(19) United States
(12) Patent Application Publication
(10) Pub. No.: US 2024/0323804 A1
(43) Pub. Date: Sep. 26, 2024

(54) ACCESS CONTROL FOR DUAL CONNECTIVITY

(71) Applicant: Telefonaktiebolaget LM Ericsson (publ), Stockholm (SE)

(72) Inventors: Pontus WALLENTIN, Linköping (SE); Jens BERGQVIST, Linköping (SE)

(21) Appl. No.: 18/578,144

(22) PCT Filed: Jun. 30, 2022
(86) PCT No.: PCT/SE2022/050662

§ 371 Date: Jan. 10, 2024

Related U.S. Application Data
(60) Provisional application No. 63/221,999, filed on Jul. 15, 2021.

(51) Int. Cl. H04W 48/02

(52) U.S. Cl. CPC H04W 48/02

(57) ABSTRACT

A method in a wireless communication device configured in dual connectivity with a master cell group, MCG, controlled by a master node, MN, and a secondary cell group, SCG, controlled by a secondary node, SN, to perform access barring check. The method includes receiving SCG access barring information. The method further includes identifying an access attempt. The method further includes determining an access category for the access attempt. The method further includes performing an access barring check for the access attempt using the access category determined and access barring information.

### TECHNICAL FIELD

The present disclosure relates generally to communications, and more particularly to communication methods and related devices and nodes supporting wireless communications.

### BACKGROUND

### Access Control

In cellular systems, such as 5G/NR (new radio), there are multiple mechanisms that can be used to prevent congestion and overload. One aim for these overload control mechanisms is to ensure that high priority services, such as public safety services and emergency calls, can gain access to the system (including for example a cell, a service or a network node) also in times of congestion and overload. FIG. 1 illustrates different types of available overload control mechanisms that may be used and are exemplified in FIG. 1 as function of the system load.

During normal operation and light load, regular scheduling can be used to ensure that the Quality of Service (QOS) targets are met for the user equipments (UEs) in a given cell. At higher loads, the network may decide to apply backoff mechanisms towards the UE performing random access and/or release/reject the UEs, possibly with a wait timer, to allow UEs to come back for a retry after a certain period. As a last resort, when other overload mechanisms are not enough to reduce the load, access barring (also known as access control) is applied to prohibit a portion of the UEs to access the system while still allow a limited of traffic, including high priority services such as emergency.

### Access Barring in 5G

The main purpose of access barring is to redistribute the access requests of UEs through time to reduce the number of simultaneous access attempts. By applying different barring rates for low and high priority services it is also possible to ensure that the high priority services can access the system. Access barring is used to protect the system and/or high-priority services/users at times of extreme overload, but also when system capacity is lower than normal for some reason, such as during maintenance or at extreme circumstances such as a disaster.

During the years of standardization of 4G/LTE (long term evolution), several access barring mechanisms have been introduced. Examples of these mechanism include:
Access Class Barring (ACB) introduced in 3GPP Rel-8
Service Specific Access Control (SSAC) introduced in 3GPP Rel-9
Access control for Circuit-Switched Fallback (CSFB) introduced in 3GPP Rel-10
Extended Access Barring (EAB) introduced in 3GPP Rel-11
ACB skip introduced in 3GPP Rel-12
Application specific Congestion control for Data Communication (ACDC) introduced in 3GPP Rel-12
Access barring for NB-IoT, introduced in Rel-13.
RSRP-based (=coverage based) access barring for LTE-M and NB-IoT, introduced in Rel-15.

In 5G, the above access barring mechanisms were unified into a single mechanism that can be adapted based on operator needs and that can address the same use cases. This mechanism is known as Unified Access Control (UAC). UAC is used when the UE is connected in a 5G core network (5GC) using NR or LTE radio access (the latter case is also known as LTE/5GC). UAC is applicable in all UE RRC (radio resource control) states (such as RRC_IDLE, RRC_INACTIVE and RRC_CONNECTED).

In UAC, there is a process in the UE which detects what is referred to as “access attempts”. For example, an access attempts may be a request to setup a new session, such as a new PDU session or an MMTEL Voice call. Another examples of access attempts are certain UE initiated (also known as Mobile Originated, MO) signalling procedures, such as registration procedures. Each access attempt is categorized into an access category according to certain rules that are defined in the standard or configured by the operator. For each access category for which barring is applied, access barring information is broadcasted in system information (more specifically in SIB1 (system information block 1)) consisting of a barring factor and a barring time. The UE draws a random number in the range 0-1 and if it is lower than the barring factor the access attempt is barred for a random time which depends on the barring time.

Table 1 below from 3GPP TS 22.261 v18.2.0 clause 6.22 gives an overview of the access categories specified in UAC. In total there are 64 access categories available in UAC where access categories 0-31 are standardized and access categories 32-63 are operator defined. Note that currently (3GPP TS 22.261, v18.2.0) only the first 11 (that is, access category numbers 0-10) standardized access categories have been defined; the rest are reserved for future use.

| Access | | |
|---|---|---|
| Category | | |
| number | Conditions related to UE | Type of access attempt |
| 0 | All | MO signalling resulting from |
| | | paging |
| 1 | UE is configured for delay tolerant | All except for Emergency, or |
| (NOTE 1) | service and subject to access control for | MO exception data |
| | Access Category 1, which is judged | |
| | based on relation of UE's HPLMN and | |
| | the selected PLMN. | |
| 2 | All | Emergency |
| 3 | All except for the conditions in Access | MO signalling on NAS level |
| | Category 1. | resulting from other than paging |
| 4 | All except for the conditions in Access | MMTEL voice (NOTE 3) |
| | Category 1. | |
| 5 | All except for the conditions in Access | MMTEL video |
| | Category 1. | |
| 6 | All except for the conditions in Access | SMS |
| | Category 1. | |
| 7 | All except for the conditions in Access | MO data that do not belong to |
| | Category 1. | any other Access Categories |
| | | (NOTE 4) |
| e | All except for the conditions in Access | MO signalling on RRC level |
| | Category 1 | resulting from other than paging |
| 9 | All except for the conditions in Access | MO IMS registration related |
| | Category 1 | signalling (NOTE 5) |
| 10 | All | MO exception data |
| (NOTE 6) | | |
| 11-31 | | Reserved standardized Access |
| | | Categories |
| 32-63 | All | Based on operator classification |
| (NOTE 2) | | |

(NOTE 1:)
The barring parameter for Access Category 1 is accompanied with information that define whether Access Category applies to UEs within one of the following categories:
a) UEs that are configured for delay tolerant service;
b) UEs that are configured for delay tolerant service and are neither in their HPLMN nor in a PLMN that is equivalent to it;
c) UEs that are configured for delay tolerant service and are neither in the PLMN listed as most preferred PLMN of the country where the UE is roaming in the operator-defined PLMN selector list on the SIM/USIM, nor in their HPLMN nor in a PLMN that is equivalent to their HPLMN.
When a UE is configured for EAB, the UE is also configured for delay tolerant service. In case a UE is configured both for EAB and for EAB override, when upper layer indicates to override Access Category 1, then Access Category 1 is not applicable.
(NOTE 2:)
When there are an Access Category based on operator classification and a standardized Access Category to both of which an access attempt can be categorized, and the standardized Access Category is neither 0 nor 2, the UE applies the Access Category based on operator classification. When there are an Access Category based on operator classification and a standardized Access Category to both of which an access attempt can be categorized, and the standardized Access Category is 0 or 2, the UE applies the standardized Access Category.
(NOTE 3:)
Includes Real-Time Text (RTT).
(NOTE 4:)
Includes IMS Messaging.
(NOTE 5:)
Includes IMS registration related signalling, e.g., IMS initial registration, reregistration, and subscription refresh.
(NOTE 6:)
Applies to access of a NB-IoT-capable UE to a NB-IOT cell connected to 5GC when the UE is authorized to send exception data.

In addition to the access category, each access attempt is also associated with one or more access identities which is used to allow certain types of UEs to bypass the access barring check for an access category. Normal UEs are mapped to access identity 0 while “special” UEs are mapped to access identities 1 and above (see also 3GPP TS 22.261 v18.2.0).

If the traffic load changes the network can enable or disable access barring for one or more access categories by updating the access barring information broadcasted in SIB1. As for other types of system information changes, the base station can notify the UEs in cell that the system information is updated by broadcasting an SI change indication in the cell. When a UE receives this indication it acquires and applies the updated system information. The UE can also regularly check for updates to system information by checking the value tag information broadcasted in SIB1.

The following excerpt from 3GPP TS 38.331 v16.4.1 shows the access barring information uac-BarringInfo which is broadcasted for each access category in SIB1. As can be seen the barring factor (uac-BarringFactor) ranges from 0 (meaning that all access attempts are barred) to 0.95 (meaning that 5 percent of the access attempts are barred) and the barring time (uac-BarringTime) ranges from 4s up to 512s. The access identities which are allowed to bypass the access check are indicated using a 7 bit bitmap (uac-BarringForAccessIdentity) in the broadcasted barring information. If any of the UE's access identities is set to 0 in the bitmap, the access barring check is skipped for the access category and the UE is allowed to proceed with the access attempt.

SIB1 message
-- ASN1START
-- TAG-SIB1-START
SIB1 ::= SEQUENCE {
<lines skipped>
uac-BarringInfo SEQUENCE {

| | | |
|---|---|---|
| uac-BarringForCommon | AC-BarringPerCatList | OPTIONAL, -- Need S |
| uac-BarringPerPLMN-List | UAC-BarringPerPLMN-List | OPTIONAL, -- Need S |

| | |
|---|---|
| uac-BarringInfoSetList | UAC-BarringInfoSetList, |

uac-AccessCategory1-SelectionAssistanceInfo CHOICE {

| | |
|---|---|
| plmnCommon | UAC-AccessCategory1-SelectionAssistanceInfo, |
| individualPLMNList | SEQUENCE (SIZE (2..maxPLMN)) OF UAC- |

AccessCategory1-SelectionAssistanceInfo

| | |
|---|---|
| } | OPTIONAL -- Need S |

```
  }
<lines skipped>
}
SIB1-v1630-IEs ::= SEQUENCE {
  uac-BarringInfo-v1630 SEQUENCE {
    uac-AC1-SelectAssistInfo-r16 SEQUENCE (SIZE (2..maxPLMN)) OF UAC-AC1-
SelectAssistInfo-r16
```

| | |
|---|---|
| } | OPTIONAL, -- Need R |
| nonCriticalExtension SEQUENCE { } | OPTIONAL |

}
UAC-AccessCategory1-SelectionAssistanceInfo ::= ENUMERATED {a, b, c}
UAC-AC1-SelectAssistInfo-r16 ::= ENUMERATED {a, b, c, notConfigured}
-- TAG-SIB1-STOP

UAC-BarringInfoSetList information element
-- ASN1START
-- TAG-UAC-BARRINGINFOSETLIST-START

| | |
|---|---|
| UAC-BarringInfoSetList ::= | SEQUENCE (SIZE(1..maxBarringInfoSet)) OF UAC- |

BarringInfoSet

| | |
|---|---|
| UAC-BarringInfoSet ::= | SEQUENCE { |
| uac-BarringFactor | ENUMERATED {p00, p05, p10, p15, p20, p25, p30, p40, |
| | p50, p60, p70, p75, p80, p85, p90, p95} |
| uac-BarringTime | ENUMERATED {s4, s8, s16, s32, s64, s128, s256, s512} |
| uac-BarringForAccessIdentity | BIT STRING (SIZE(7)) |

}
-- TAG-UAC-BARRINGINFOSETLIST-STOP
-- ASN1STOP

The mapping between access attempts and access categories in UAC are shown in Table 2 below copied from 3GPP TS 24.501 v17.2.1. The mapping rules for the standardized access categories are pre-defined in the standard while the mapping rules for the operator defined are signaled to the UE using NAS (non-access stratum) signaling.

| | Type of access | | Access |
|---|---|---|---|
| Rule # | attempt | Requirements to be met | Category |
| 1 | Response to paging or | Access attempt is for MT access, or | 0 (=MT_acc) |
| | NOTIFICATION over | handover of ongoing MMTEL voice | |
| | non-3GPP access (NOTE 11); | call, MMTEL video call or SMSoIP | |
| | 5GMM connection management | from non-3GPP access | |
| | procedure initiated for the | | |
| | purpose of transporting an | | |
| | LPP message without an | | |
| | ongoing 5GC-MO-LR procedure; | | |
| | Access attempt to handover | | |
| | of MMTEL voice call, MMTEL | | |
| | video call or SMSoIP | | |
| | from non-3GPP access | | |
| 2 | Emergency | UE is attempting access for an | 2 (=emergency) |
| | | emergency session (NOTE 1, | |
| | | NOTE 2) | |
| 3 | Access attempt for | UE stores operator-defined access | 32-63 |
| | operator-defined | category definitions valid in the | (=based on |
| | access category | SNPN as specified in | operator |
| | | subclause 4.5.3, and access attempt | classification) |
| | | is matching criteria of an operator- | |
| | | defined access category definition | |
| 4 | Access attempt for | (a) UE is configured for NAS | 1 (=delay |
| | delay tolerant service | signalling low priority, and | tolerant) |
| | | (b) the UE received one of the | |
| | | categories a, b or c as part of the | |
| | | parameters for unified access control | |
| | | in the broadcast system information, | |
| | | and the UE is a member of the | |
| | | broadcasted category in the selected | |
| | | SNPN or RSNPN | |
| | | (NOTE 3, NOTE 5, NOTE 6, | |
| | | NOTE 7, NOTE 8) | |
| 4.1 | MO IMS registration | Access attempt is for MO IMS | 9 (=MO |
| | related signalling | registration related signalling (e.g., | IMS |
| | | IMS initial registration, re- | registration |
| | | registration, subscription refresh) | related |
| | | or for NAS signalling connection | signalling) |
| | | recovery during ongoing procedure | |
| | | for MO IMS registration related | |
| | | signalling (NOTE 2a) | |
| 5 | MO MMTel voice | Access attempt is for MO MMTel | 4 (=MO |
| | call | voice call | MMTel |
| | | or for NAS signalling connection | voice) |
| | | recovery during ongoing MO | |
| | | MMTel voice call (NOTE 2) | |
| 6 | MO MMTel video | Access attempt is for MO MMTel | 5 (=MO |
| | call | video call | MMTel |
| | | or for NAS signalling connection | video) |
| | | recovery during ongoing MO | |
| | | MMTel video call (NOTE 2) | |
| 7 | MO SMS over NAS | Access attempt is for MO SMS over | 6 (=MO |
| | or MO SMSoIP | NAS (NOTE 4) or MO SMS over | SMS and |
| | | SMSoIP transfer | SMSoIP) |
| | | or for NAS signalling connection | |
| | | recovery during ongoing MO SMS | |
| | | or SMSoIP transfer (NOTE 2) | |
| 8 | UE NAS initiated | Access attempt is for MO signalling | 3 (=MO_sig) |
| | 5GMM specific | | |
| | procedures | | |
| 8.1 | Mobile originated | Access attempt is for mobile | 3 (=MO_sig) |
| | location request | originated location request | |
| | | (NOTE 9) | |
| 8.2 | Mobile originated | Access attempt is for mobile | 3 (=MO_sig) |
| | signalling transaction | originated signalling transaction | |
| | towards the PCF | towards the PCF (NOTE 10) | |
| 9 | UE NAS initiated | Access attempt is for MO data | 7 (=MO_data) |
| | 5GMM connection | | |
| | management | | |
| | procedure or 5GMM | | |
| | NAS transport | | |
| | procedure | | |
| 10 | An uplink user data | No further requirement is to be met | 7 (=MO_data) |
| | packet is to be sent | | |
| | for a PDU session | | |
| | with suspended user- | | |
| | plane resources | | |

(NOTE 1:)
In this release of the specification, there is no support for establishing an emergency session in an SNPN.
(NOTE 2:)
Access for the purpose of NAS signalling connection recovery during an ongoing service as defined in subclause 4.5.5, or for the purpose of NAS signalling connection establishment following fallback indication from lower layers during an ongoing service as defined in subclause 4.5.5, is mapped to the access category of the ongoing service in order to derive an RRC establishment cause, but barring checks will be skipped for this access attempt.
(NOTE 2a:)
Access for the purpose of NAS signalling connection recovery during an ongoing MO IMS registration related signalling as defined in subclause 4.5.5, or for the purpose of NAS signalling connection establishment following fallback indication from lower layers during an ongoing MO IMS registration related signalling as defined in subclause 4.5.5, is mapped to the access category of the MO IMS registration related signalling in order to derive an RRC establishment cause, but barring checks will be skipped for this access attempt.
(NOTE 3:)
If the UE selects a new SNPN, then the selected SNPN is used to check the membership; otherwise the UE uses the RSNPN.
(NOTE 4:)
This includes the 5GMM connection management procedures triggered by the UE-initiated NAS transport procedure for transporting the MO SMS.
(NOTE 5:)
The UE configured for NAS signalling low priority is not supported in this release of specification.
(NOTE 6:)
If the access category applicable for the access attempt is 1, then the UE shall additionally determine a second access category from the range 3 to 7. If more than one access category matches, the access category of the lowest rule number shall be chosen. The UE shall use the second access category only to derive an RRC establishment cause for the access attempt.
(NOTE 7:)
Void.
(NOTE 8:)
For the definition of categories a, b and c associated with access category 1, see 3GPP TS 22.261 [3]. The categories associated with access category 1 are distinct from the categories a, b and c associated with EAB (see 3GPP TS 22.011 [1A]).
(NOTE 9:)
This includes:
a) the UE-initiated NAS transport procedure for transporting a mobile originated location request;
b) the 5GMM connection management procedure triggered by a) above; and
c) NAS signalling connection recovery during an ongoing 5GC-MO-LR procedure.
(NOTE 10:)
This includes:
a) the UE-initiated NAS transport procedure for transporting a mobile originated signalling transaction towards the PCF;
b) the 5GMM connection management procedure triggered by a) above; and
c) NAS signalling connection recovery during an ongoing UE triggered V2X policy provisioning procedure.
(NOTE 11:)
The term “non-3GPP access” refers to the case when the UE is accessing SNPN services via a PLMN.

For the operator defined access categories, the mapping from access attempt to access category is done by matching the access attempt to one or more criteria. The mapping rules including the criterias are signaled to the UE over NAS when the operator defined access category is configured in the UE. Currently the following criterias have been defined in TS 24.501 v17.2.1:
Data Network Name (DNN)
DNN is the name of the gateway between the 5G network and the other data network (e.g. Internet). To fulfil the criteria the access attempt must be triggered by a PDU session whose DNN matches the signaled value.
OS Id+OS App Id
To fulfil this criteria the access attempt must be triggered by an application whose OS Id+OS App Id matches the signaled value.
Single Network Slice Selection Assistance Information (S-NSSAI)
S-NSSAI identifies a particular network slice. To fulfil the criteria the access attempt must be triggered by a network slice whose S-NSSAI matches the signaled value.

### Carrier Aggregation

When Carrier Aggregation (CA) is configured, the UE uses multiple carrier frequencies and each carrier corresponds to a cell. During CA, the UE still has one RRC connection with the network. Further, at RRC connection establishment/re-establishment/handover, one serving cell provides the NAS mobility information, and at RRC connection re-establishment/handover, one serving cell provides the security input. This cell is referred to as the Primary Cell (PCell). In addition, depending on UE capabilities, Secondary Cells (SCells) can be configured to form together with the PCell a set of serving cells. Therefore, when carrier aggregation is configured for the UE, the set of serving cells used by the UE always consists of one PCell and one or more SCells.

The reconfiguration, addition and removal of SCells can be performed by radio resource control (RRC). At intra-RAT (radio access technology) handover, RRC can also add, remove, or reconfigure SCells for usage with the target PCell. When adding a new SCell, dedicated RRC signalling is used for sending all required system information of the SCell i.e. while in connected mode, UEs need not acquire broadcasted system information directly from the SCells.

### 3GPP Dual Connectivity

In 3GPP Rel-12, the LTE feature Dual Connectivity (DC) was introduced, to enable the UE to be connected in two cell groups, each controlled by an LTE access node, eNBs (EUTRAN (evolved universal terrestrial radio access network) base stations), labelled as the Master eNB, MeNB and the Secondary eNB, SeNB. The UE still only has one RRC connection with the network. In 3GPP, the Dual Connectivity (DC) solution has since then been evolved and is now also specified for NR as well as between LTE and NR. With introduction of 5G, the term MR-DC (Multi-Radio Dual Connectivity, see also 3GPP TS 37.340) was defined as a generic term for all dual connectivity options which includes at least one NR access node. Using the MR-DC generalized terminology, the UE is connected in a Master Cell Group (MCG), controlled by the Master Node (MN), and in a Secondary Cell Group (SCG) controlled by a Secondary Node (SN).

Further, in MR-DC, when dual connectivity is configured for the UE, within each of the two cell groups, MCG and SCG, carrier aggregation may be used as well. In this case, within the Master Cell Group, MCG, controlled by the master node (MN), the UE may use one PCell and one or more SCell(s). And within the Secondary Cell Group, SCG, controlled by the secondary node (SN), the UE may use one Primary SCell (PSCell, also known as the primary SCG cell in NR) and one or more SCell(s). This combined case is illustrated in FIG. 2. In NR, the primary cell of a master or secondary cell group is sometimes also referred to as the Special Cell (SpCell). Hence, the SpCell in the MCG is the PCell and the SpCell in the SCG is the PSCell.

There are different ways to deploy 5G network with or without interworking with LTE (also referred to as E-UTRA (evolved universal terrestrial radio access) and evolved packet core (EPC). These different ways to deploy 5G are also known as architecture options. In principle, NR and LTE can be deployed without any interworking, denoted by NR stand-alone (SA) operation, also known as architecture option 2, that is gNB (NR base station) in NR can be connected to 5G core network (5GC) and eNB in LTE can be connected to EPC with no interconnection between the two, also known as architecture option 1.

On the other hand, the first supported version of NR uses dual connectivity, denoted as EN-DC (E-UTRAN (evolved universal terrestrial radio access network)-NR Dual Connectivity), also known as architecture option 3, as illustrated in FIG. 3. In such a deployment, dual connectivity between NR and LTE is applied, where the UE is connected with both the LTE radio interface (LTE Uu in FIG. 3) to an LTE access node and the NR radio interface (NR Uu in FIG. 3) to an NR access node. Further, in EN-DC, the LTE access node acts as the master node (in this case known as the Master eNB, MeNB), controlling the master cell group, MCG, and the NR access node acts as the secondary node (in this case sometimes also known as the Secondary gNB, SgNB), controlling the secondary cell group, SCG. The SgNB has a user plane connection S1-U to the core network (EPC). The control plane connection S1-C to the core network (EPC) is instead provided by the MeNB. This is also called as “Non-standalone NR” or, in short, “NSA NR”. Notice that in this case the functionality of an NR cell is limited and would be used for connected mode UEs as a booster and/or diversity leg, but an RRC_IDLE UE cannot camp on these NR cells. In EN-DC, there is no connection to the 5G core network (5GC).

With the introduction of 5GC, other options may be also valid. As mentioned above, option 2 supports stand-alone NR deployment where a gNB is connected to 5GC. Similarly, LTE can also be connected to 5GC using option 5 (also known as eLTE, E-UTRA/5GC, or LTE/5GC and the node can be referred to as an ng-eNB). In these cases, both NR and LTE are seen as part of the NG-RAN (next generation radio access network and both the ng-eNB and the gNB can be referred to as NG-RAN nodes).

It is worth noting that, there are also other variants of dual connectivity between LTE and NR which have been standardized as part of NG-RAN connected to 5GC. Under the MR-DC umbrella, there are:
EN-DC (also known as architecture option 3): LTE is the master node and NR is the secondary node (EPC CN employed, as depicted in FIG. 2)
NE-DC (also known as architecture option 4): NR is the master node and LTE is the secondary (5GC employed)
NGEN-DC (also known as architecture option 7): LTE is the master node and NR is the secondary (5GC employed)
NR-DC (variant of architecture option 2): Dual connectivity where both the master node, MN, controlling the MCG, and the secondary node, SN, controlling the SCG, are NR (5GC employed, as depicted in FIG. 3).

In NR-DC, illustrated in FIG. 4, the secondary node (NR SN) is a gNB, providing NR radio interface NR Uu to the UE and has a user plane connection NG-U to the 5G core network (5GC). The master node (NR MN) is also a gNB, providing NR radio interface NR Uu to the UE and has the control plane connection NG-C as well as a user plane connection NG-U to the 5G core network (5GC). Between the MN and SN, the Xn interface is used.

As stated earlier, DC is standardized for both LTE and E-UTRA-NR DC (EN-DC).

LTE DC and EN-DC are designed differently when it comes to which nodes control what. Basically, there are two options:
Centralized solution (like LTE-DC), and
Decentralized solution (like EN-DC)

FIG. 5 shows what the schematic control plane architecture looks like for LTE DC, EN-DC and NR-DC. The main difference is that in EN-DC and NR-DC, the Secondary Node, SN, has a separate NR RRC entity. This means that the SN can control the UE also; sometimes using the NR radio interface NR Uu directly to the UE without the knowledge of the MN but often the SN need to coordinate with the Master Node, MN. The UE has an LTE RRC state in EN-DC and an NR RRC state in NR-DC. Further, in LTE-DC and EN-DC, the control plane interface between MN and SN is X2-C. In LTE-DC, the RRC decisions are always coming from the MN (MN uses the LTE radio interface LTE Uu to the UE). Note however, the SN still decides the configuration of the SN, since it is only the SN itself that has knowledge of what kind of resources, capabilities etc. it has. Further, in LTE-DC, the UE has an LTE RRC state. Further, in NR-DC, the control plane interface between MN and SN is Xn-C.

For EN-DC and NR-DC, the major changes compared to LTE DC are:
The introduction of split data radio bearer (DRB) from the SN (known as SN terminated split DRB)
The introduction of split signaling radio bearer (SRB) for RRC
The introduction of a direct SRB from the SN (also referred to as SCG SRB or SRB3)

FIG. 6 shows, from a network perspective, the user plane protocol architecture in MR-DC with EPC (EN-DC). A bearer may be categorized into a bearer type. Each bearer type is characterized by which radio resources that are involved. For an MCG bearer, only MCG radio resources and radio link control+medium access control (RLC+MAC) layer entities for the MCG are involved. For an SCG bearer, only SCG radio resources and RLC+MAC layer entities for the SCG are involved. For a split bearer, both MCG and SCG radio resources as well as RLC+MAC layer entities for both the MCG and SCG are involved. Further, a bearer may also be categorized into MN terminated bearers and SN terminated bearers depending on which network node where they are terminated. For MN terminated bearers, the PDCP (packet data convergence protocol) layer entity and the user plane connection to the core network is terminated in the MN. For SN terminated bearers, the PDCP layer entity and the user plane connection to the core network is terminated in the SN.

The network can configure either E-UTRA PDCP layer or NR PDCP layer for MN terminated MCG bearers while NR PDCP layer is always used for all other bearers. In this case, the network can configure either E-UTRA PDCP or NR PDCP for MN terminated MCG DRBs while NR PDCP is always used for all other DRBs.

FIG. 7 shows, from a network perspective, the user plane protocol architecture in MR-DC with 5GC (NGEN-DC, NE-DC and NR-DC). In MR-DC with 5GC, NR PDCP is always used for all DRB types. In NGEN-DC, E-UTRA RLC/MAC is used in the MN while NR RLC/MAC is used in the SN. In NE-DC, NR RLC/MAC is used in the MN while E-UTRA RLC/MAC is used in the SN. In NR-DC, NR RLC/MAC is used in both MN and SN.

### SCG Power Saving Mode

In order to improve network energy efficiency and UE battery life for UEs in MR-DC, a Rel-17 work item aims to introduce a feature known as efficient SCG/SCell activation/deactivation. This can be especially important for MR-DC configurations with NR SCG, as it has been evaluated in RP-190919 that in some cases NR UE power consumption is 3 to 4 times higher than LTE.

3GPP has already specified the concept of deactivated SCell for LTE and NR. As depicted in FIG. 8, for NR, a given SCell can be in either “Deactivated SCell” state or “Activated SCell” state. The configured SCell(s) may be activated and deactivated by transmitting the SCell Activation/Deactivation MAC CE (medium access control control element) from the network to the UE. The SCell may also be deactivated upon expiry of a timer configured per SCell, known as the sCellDeactivationTimer. As a third option, the SCell state may be configured by RRC signalling.

3GPP has also specified the concepts of dormant SCell (in LTE) and dormancy like behavior of an SCell (for NR). In LTE, when an SCell is in dormant state, like in the Deactivated SCell state, the UE does not need to monitor the corresponding PDCCH (physical downlink control channel) or PDSCH (physical downlink shared channel) and cannot transmit in the corresponding uplink. However, differently from deactivated state, the UE is required to perform and report CQI (channel quality indicator) measurements. A PUCCH (physical uplink control channel) SCell (SCell configured with PUCCH) cannot be in dormant state.

In NR, as also illustrated in FIG. 8, dormancy like behaviour for SCells is realized using the concept of dormant bandwidth parts (BWPs). When the SCell is activated, the active BWP used by the SCell can be switched between a “non-dormant” BWP and a dormant BWP. One dormant BWP, which is one of the dedicated BWPs configured by the network via RRC signaling, can be configured for an SCell. If the active BWP of the activated SCell is a dormant BWP, the UE stops monitoring PDCCH on the SCell but continues performing CSI (channel state information) measurements, AGC (automatic gain control) and beam management, if configured. A DCI (downlink control information) is used to control entering/leaving the dormant BWP for one or more SCell(s) or one or more SCell group(s), and it is sent to the special cell (SpCell) of the cell group that the SCell belongs to (i.e. PCell in case the SCell belongs to the MCG and PSCell if the SCell belongs to the SCG). The SpCell (i.e. PCell of PSCell) and PUCCH SCell cannot be configured with a dormant BWP.

However, only SCells can be put to dormant state (in LTE) or operate in dormancy like behavior (NR). Also, only SCells can be put into the deactivated state in both LTE and NR. Thus, if the UE is configured with MR-DC, it is not possible to fully benefit from the power saving options of dormant state or dormancy like behavior as the PSCell cannot be configured with that feature. Instead, an existing solution could be releasing (for power savings) and adding (when traffic demands requires) the SCG on a need basis. However, traffic is likely to be bursty, and adding and releasing the SCG involves a significant amount of RRC signaling and inter-node messaging between the MN and the SN, which causes considerable delay.

In 3GPP Rel-16, some discussions were made regarding putting also the PSCell in dormancy, also referred to as SCG Suspension. Some preliminary agreements were made on that the UE supports network-controlled suspension of the SCG in RRC_CONNECTED but that UE behavior for a suspended SCG is FFS (for future study).

The 3GPP discussions on solutions for the Rel-17 MR-DC work item objective “Support efficient activation/de-activation mechanism for one SCG and Scells” have just started in 3GPP RAN1, RAN2 and RAN3. As part of this objective, the concept of a “deactivated SCG” with aim of power saving when the traffic demands are dynamically reduced is being discussed. As FIG. 9 illustrates, there are two SCG states (sometimes referred to as states for SCG activation or states for PSCell activation) being discussed, here referred to as “SCG deactivated state” and “SCG activated state”. These states concern the power saving mode for the SCG and should not be confused with the RRC states.

A current RAN2 assumption is that during “SCG deactivated state,” or sometimes referred to as when “SCG is deactivated”, or in an “deactivated PSCell” state, in order to save power, the UE does not perform PDCCH (physical downlink control channel) monitoring of the PSCell. This also means that UL/DL data transmission in the SCG is suspended when the SCG is in SCG deactivated state. Activation and deactivation of the SCG is typically controlled by the network, e.g. by the MN, using RRC signalling. Moreover, RAN2 has agreed that PSCell mobility is supported while the SCG is deactivated, even if details are FFS. When the UE is configured with the SCG in “SCG activated state” the power saving of the SCG is not applied.

### Inter-Node Signalling for Load Indications

In E-UTRAN for LTE, there are two procedures which can be used to inform other network nodes (eNBs) of resource usage information such as load. The Load Indication procedure, specified in 3GPP TS 36.423 is illustrated in FIG. 10.

Also, the Resource Status Reporting Initiation can be used in LTE by one eNB to request reporting of load measurements to another eNB. These load measurements are then reported using the Resource Status Reporting procedure to the other eNB, which is illustrated in FIG. 11.

There currently exist certain challenge(s). For a UE which uses dual connectivity, such as MR-DC with a Master Cell Group (MCG), controlled by a Master Node (MN) and a secondary cell group (SCG), controlled by a Secondary Node (SN), the network applies access barring using the system information (i.e. in SIB1) in the Primary Cell (PCell) in the MCG. This leads to several challenges. If the secondary cell group is affected by severe or rapidly increasing overload or if a disaster happens, the methods to mitigate this are currently limited. For example, in case of low load levels, the MN and SN can perform QoS-aware scheduling of user data in the SCG for SCG bearers and split bearers, in order to ensure all UEs that currently use the cells in the SCG gets the required QoS. And in case of higher load levels, the MN and SN can reject any UE requests to setup the SCG or release SCells or even releasing the whole SCG.

But in case of severe or rapidly increasing overload or if system maintenance a disaster happens, the amount of traffic may cause that UEs do not get their required QoS, or even a complete outage of cells or network nodes, including the SCG cells and the SN. This is because, currently, a network node suffering from overload, can indicate the overload to it's neighbour network nodes using for example the Load Indication procedure for LTE or the Resource Status Reporting procedure for LTE and NR, including for MR-DC. If a network node, acting as the MN for a particular UE receives the indication of overload from another network node, acting as the SN for this UE, the MN could take actions such as release the SCG or deactivate the SCG for this UE and all other UEs that uses this node as the MN and the node that indicated overload as the SN. However, in case of severe overload or a rapidly increasing overload, performing these release or deactivation actions per UE basis may take longer time than required in order to reduce the overload. In other words, these existing mechanisms may not be enough. For example, in an extreme situation, such a disaster, many UEs simultaneously create traffic, preventing for example public safety services to access the system due to the overload caused by the massive amount of rapidly increased traffic. Or for example, in case of an outage or maintenance of the network node, that is used as an SN by many UEs, these UE get immediately affected by the outage or maintenance of the network node if “soft” methods to reduce the load are not enough.

### SUMMARY

The current access barring mechanisms, such as UAC, are designed to cope with these situations of severe overload or extreme situations but they only work on single cell basis. For example, if the MN applies access barring in the PCell of the MCG it will affect the traffic using the PCell and the SCells in the MCG and the MN itself.

Hence, there is a need for an efficient mechanism to mitigate overload in a dual connectivity scenario, including the overload caused by UEs using an SN and/or SCG, in extreme situations when existing mechanisms are not enough.

Certain aspects of the disclosure and their embodiments may provide solutions to these or other challenges. According to some embodiments of inventive concepts, a method in a wireless communication device configured in dual connectivity with a master cell group, MCG, controlled by a master node, MN, and a secondary cell group, SCG, controlled by a secondary node, SN, to perform access barring check includes receiving SCG access barring information. The method includes identifying an access attempt. The method includes determining an access category for the access attempt. The method includes performing an access barring check for the access attempt using the access category determined and access barring information.

According to some other embodiments of inventive concepts, the wireless communication device (e.g., the UE) receives SCG access barring information. The wireless communication device identifies an access attempt. The wireless communication device determines an access category for the access attempt. The wireless communication device performs an access barring check for the access attempt using the access category determined and access barring information. An example of an access attempt that may use SCG access barring information is UE-triggered initiated SCG activation.

Computer programs and computer program products having analogous recitations to the wireless communication device and method claims are also provided.

According to further embodiments of inventive concepts, a method in a network node to perform access barring includes generating secondary cell group (SCG) access barring information. The method includes sending the SCG access barring information towards a user equipment (UE) configured in dual connectivity using the network node as a secondary node (SN).

According to some other embodiments of inventive concepts, a network node, such as a Secondary Node (SN), generates secondary cell group, SCG, access barring information. The network node sends the SCG access barring information towards a user equipment, UE, configured in dual connectivity using the network node as a secondary node, SN.

This SCG access barring information can either be transmitted in a dedicated, per UE basis, manner, such as using SRB1 via the MN or SRB3 from the SN directly to the UE (e.g. as part of system information or serving cell information for the PSCell/SCG that is sent as dedicated signalling to the UE via the MCG/PCell), or in system information broadcasted by the MN in the PCell of the MCG or system information broadcasted by the SN in the PSCell in the SCG.

Computer programs and computer program products having analogous recitations to the network node and method claims are also provided.

Certain embodiments may provide one or more of the following technical advantage(s). A network node, such as a Secondary Node (SN), can use access barring to control the overload caused by UEs using resources controlled by the SN, (including the PSCell and SCell of the SCG. The various embodiments of inventive concepts can be used to avoid overload of the network node, caused by UEs using the network node as a secondary node, or resources controlled by the network node, such as cells.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of an overview of overload control mechanisms;

FIG. 2 is an illustration of dual connectivity combined with carrier aggregation in MR-DC;

FIG. 3 is an illustration of E-UTRAN-NR Dual Connectivity (EN-DC) according to some embodiments;

FIG. 4 is an illustration of new radio-dual connectivity (NR-DC) according to some embodiments;

FIG. 5 is an illustration of the control plane architecture for Dual Connectivity in LTE DC, EN-DC, and NR-DC according to some embodiments;

FIG. 6 is an illustration of network side protocol termination options for MCG, SCG and split bearers in MR-DC with EPC (EN-DC) according to some embodiments;

FIG. 7 is an illustration of network side protocol termination options for MCG, SCG and split bearers in MR-DC with 5GC (NGEN-DC, NE-DC and NR-DC) according to some embodiments;

FIG. 8 is an illustration of dormancy like behavior for SCells in NR according to some embodiments;

FIG. 9 is an illustration of SCG states according to some embodiments;

FIG. 10 is a signaling diagram of a load indication procedure in LTE according to some embodiments;

FIG. 11 is a signaling diagram of a resource status reporting procedure in LTE according to some embodiments;

FIG. 12 is an illustration of nodes relevant for various embodiments of inventive concepts described herein;

FIG. 13 is a flow chart illustrating operations of a wireless device UE according to some embodiments of inventive concepts;

FIG. 14 is a block diagram illustrating a wireless communication device UE according to some embodiments of inventive concepts;

FIG. 15 is a block diagram illustrating a secondary node according to some embodiments of inventive concepts;

FIG. 16 is a block diagram illustrating a master node according to some embodiments of inventive concepts;

FIGS. 17-20 are flow charts illustrating operations of a wireless communication device according to some embodiments of inventive concepts;

FIGS. 21-22 are flow charts illustrating operations of a network node acting as a secondary node according to some embodiments of inventive concepts;

FIG. 23 is a block diagram of a communication system in accordance with some embodiments;

FIG. 24 is a block diagram of a user equipment in accordance with some embodiments;

FIG. 25 is a block diagram of a network node in accordance with some embodiments;

FIG. 25 is a block diagram of a host computer communicating with a user equipment in accordance with some embodiments;

FIG. 27 is a block diagram of a virtualization environment in accordance with some embodiments; and

FIG. 28 is a block diagram of a host computer communicating via a base station with a user equipment over a partially wireless connection in accordance with some embodiments in accordance with some embodiments.

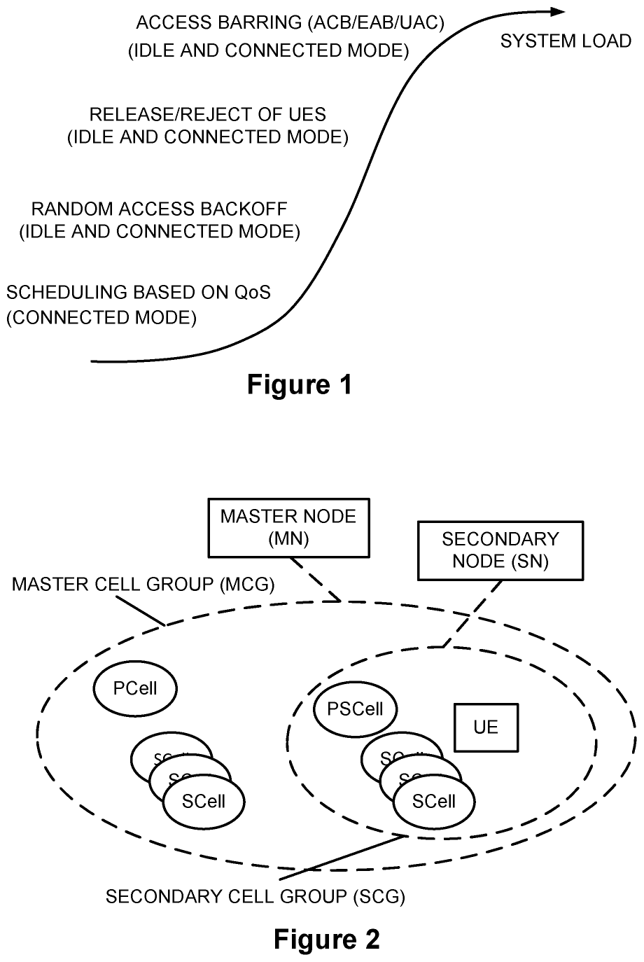

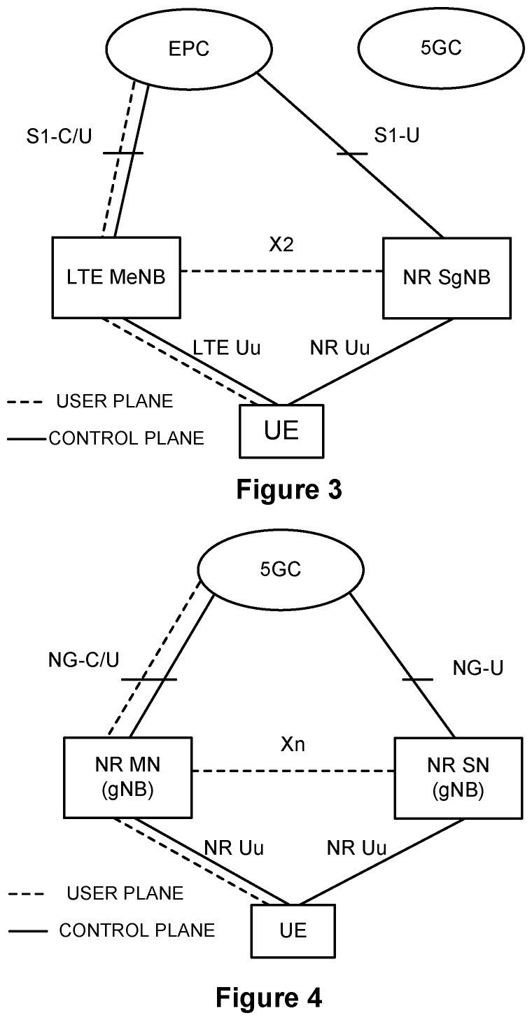

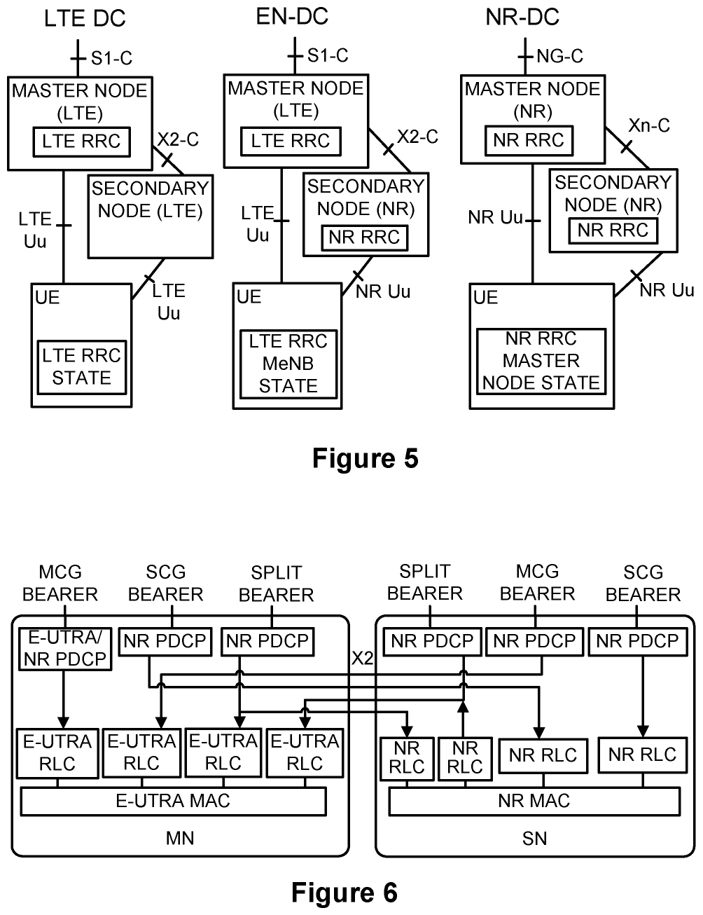

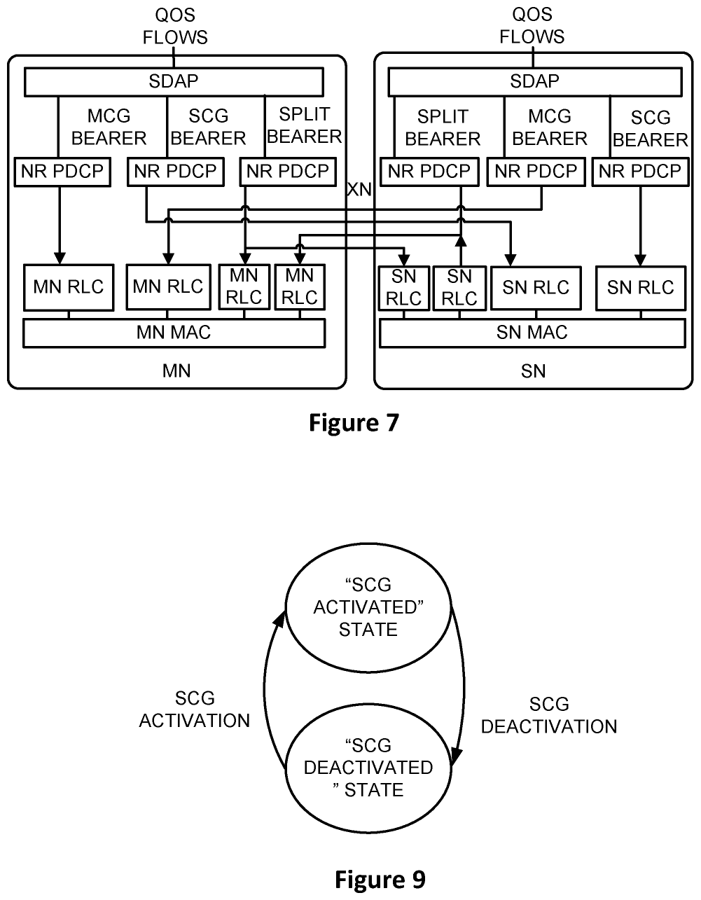

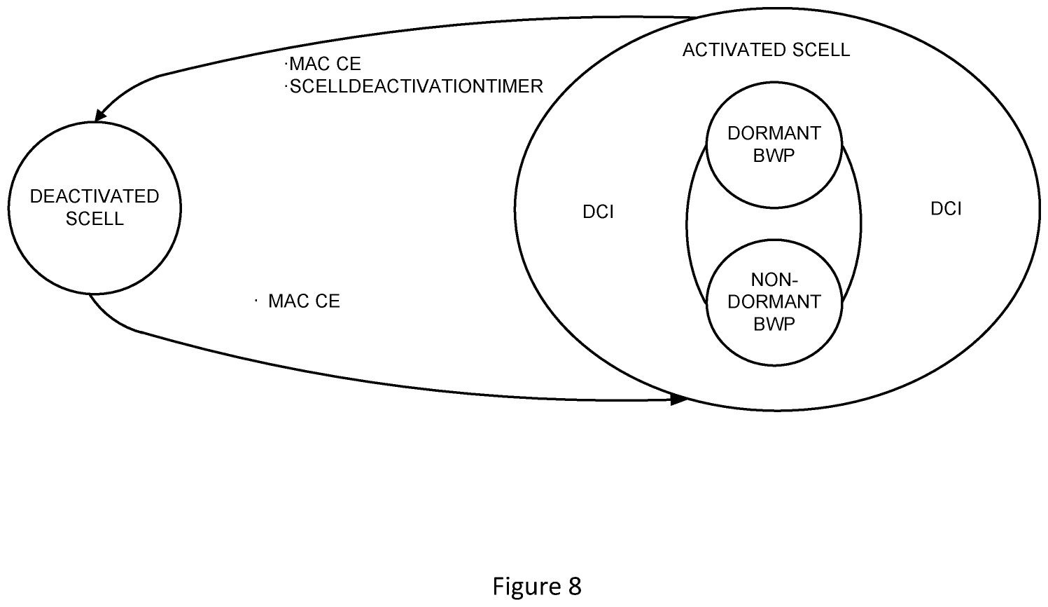

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, there is a need for an efficient mechanism to mitigate overload in a dual connectivity scenario, including the overload caused by UEs using an SN and/or SCG, in extreme situations when existing mechanisms are not enough.

Various embodiments of inventive concepts enable a network node, such as a Secondary Node (SN), to use access barring to control the overload caused by UEs using resources controlled by the SN, (including the PSCell and SCell of the SCG. The invention can be used to avoid overload of the network node, caused by UEs using the network node as a secondary node, or resources controlled by the network node, such as cells.

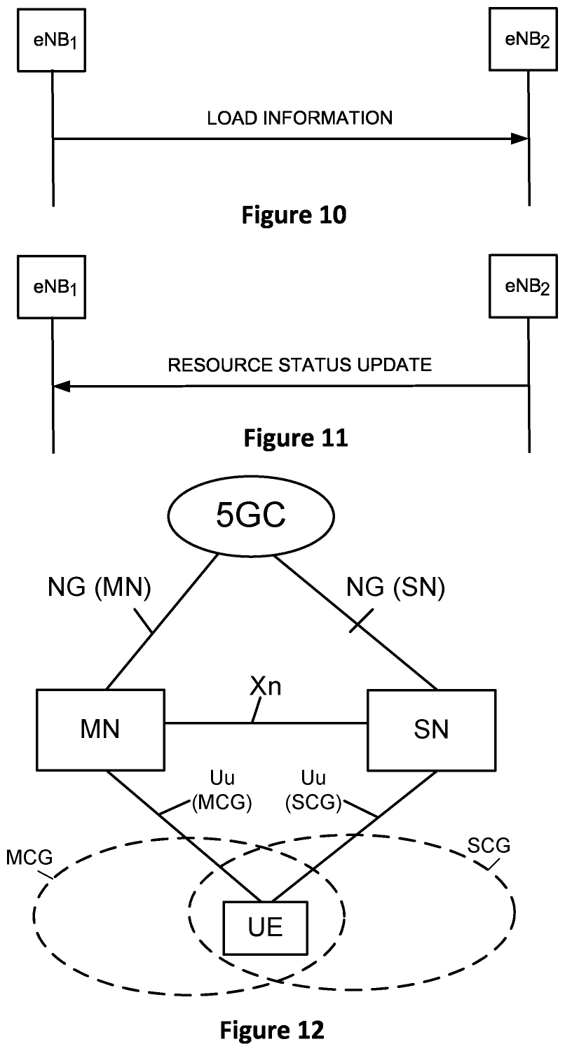

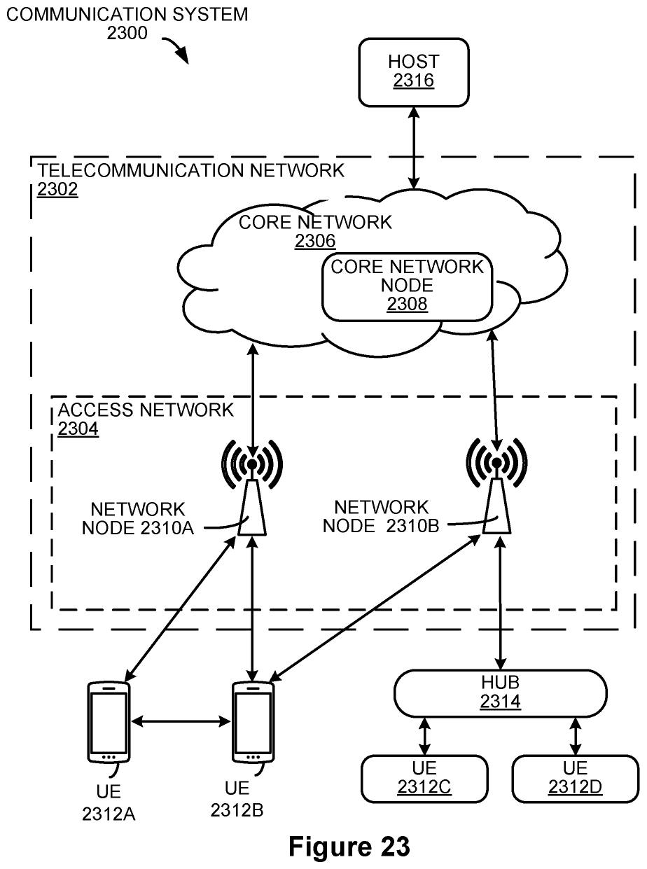

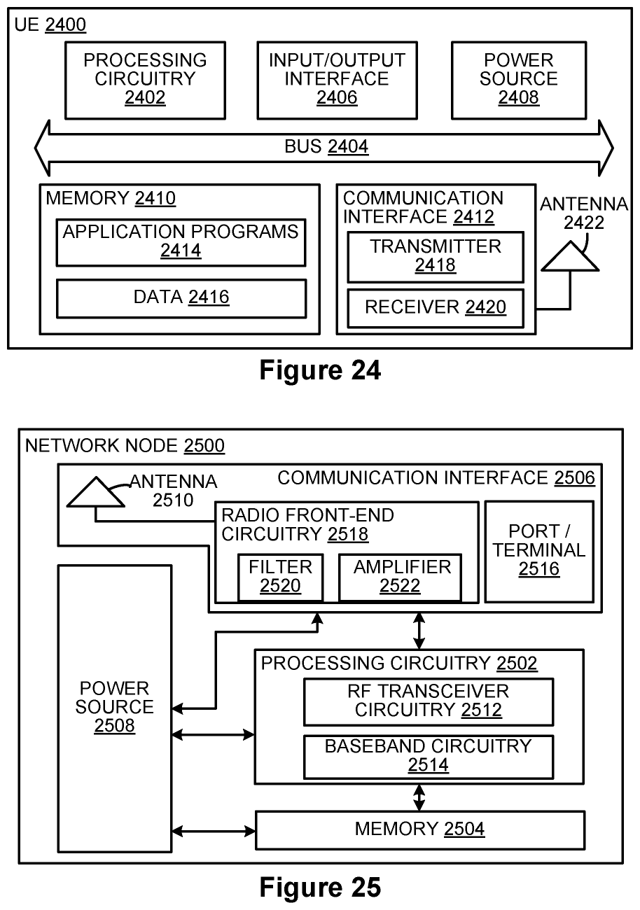

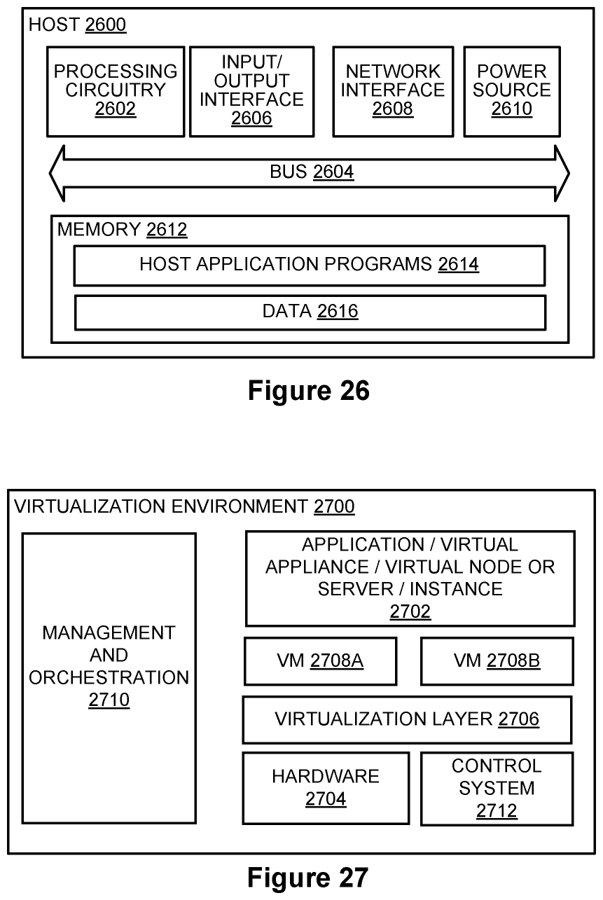

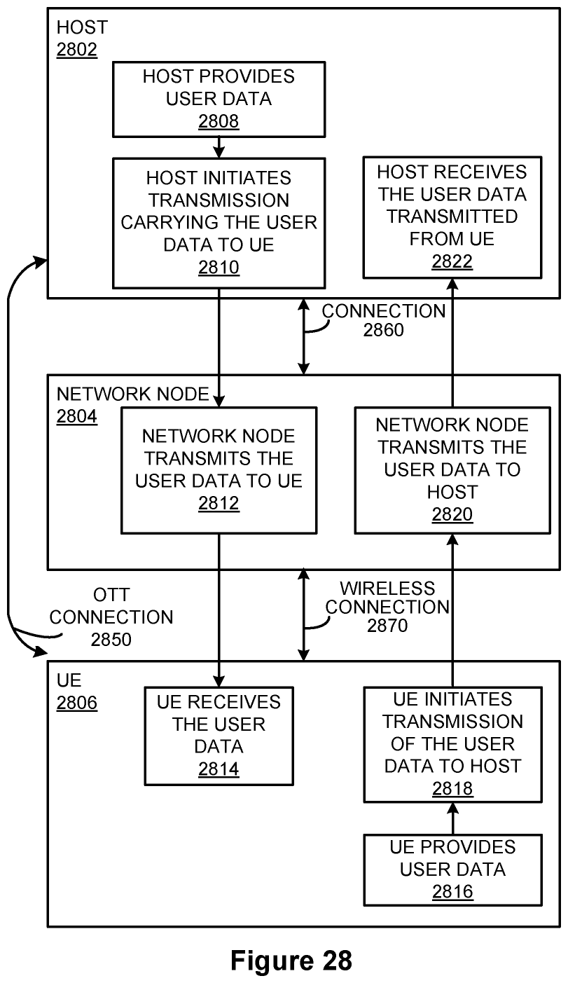

Prior to discussing various embodiments of inventive concepts, FIG. 10 is a block diagram illustrating elements of a communication device UE 1400 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device UE 1400 may be provided, for example, as discussed below with respect to wireless devices UE 2312A, UE 2312B, and wired or wireless devices UE 2312C, UE 2312D of FIG. 23, UE 2400 of FIG. 24, virtualization hardware 2704 and virtual machines 2708A, 2708B of FIG. 27, and UE 2806 of FIG. 28, all of which should be considered interchangeable in the examples and embodiments described herein and be within the intended scope of this disclosure, unless otherwise noted.) As shown, communication device UE 1400 may include an antenna 1407 (e.g., corresponding to antenna 2422 of FIG. 24), and transceiver circuitry 1401 (also referred to as a transceiver, e.g., corresponding to interface 2412 of FIG. 24 having transmitter 2418 and receiver 2420) including a transmitter and a receiver configured to provide uplink and downlink radio communications with a base station(s) (e.g., corresponding to network node 2310A, 2310B of FIG. 23, network node 2500 of FIG. 25, and network node 2804 of FIG. 28 also referred to as a RAN node) of a radio access network. Communication device UE 1400 may also include processing circuitry 1403 (also referred to as a processor, e.g., corresponding to processing circuitry 2402 of FIG. 24, and control system 2712 of FIG. 27) coupled to the transceiver circuitry, and memory circuitry 1405 (also referred to as memory, e.g., corresponding to memory 2410 of FIG. 23) coupled to the processing circuitry. The memory circuitry 1405 may include computer readable program code that when executed by the processing circuitry 1403 causes the processing circuitry to perform operations according to embodiments disclosed herein. According to other embodiments, processing circuitry 1403 may be defined to include memory so that separate memory circuitry is not required. Communication device UE 1400 may also include an interface (such as a user interface) coupled with processing circuitry 1403.

As discussed herein, operations of communication device UE 1400 may be performed by processing circuitry 1403 and/or transceiver circuitry 1401. For example, processing circuitry 1403 may control transceiver circuitry 1401 to transmit communications through transceiver circuitry 1401 over a radio interface to a radio access network node (also referred to as a base station) and/or to receive communications through transceiver circuitry 1401 from a RAN node over a radio interface. Moreover, modules may be stored in memory circuitry 1405, and these modules may provide instructions so that when instructions of a module are executed by processing circuitry 1403, processing circuitry 1403 performs respective operations (e.g., operations discussed below with respect to Example Embodiments relating to wireless communication devices). According to some embodiments, a communication device UE 1400 and/or an element(s)/function(s) thereof may be embodied as a virtual node/nodes and/or a virtual machine/machines.

FIG. 15 is a block diagram illustrating elements of a secondary node 1500 (also referred to as a SN, a network node, base station, eNodeB/eNB, gNodeB/gNB, etc.) of a Radio Access Network (RAN) configured to provide cellular communication according to embodiments of inventive concepts. (Secondary node 1500 may be provided, for example, as discussed below with respect to network node 2310A, 2310B of FIG. 23, network node 2500 of FIG. 25, hardware 2704 or virtual machine 2708A, 2708B of FIG. 27, and/or base station 2804 of FIG. 28, all of which should be considered interchangeable in the examples and embodiments described herein and be within the intended scope of this disclosure, unless otherwise noted.) As shown, the SN 1500 may include transceiver circuitry 1501 (also referred to as a transceiver, e.g., corresponding to portions of RF transceiver circuitry 2512 and radio front end circuitry 2518 of FIG. 25) including a transmitter and a receiver configured to provide uplink and downlink radio communications with mobile terminals. The SN 1500 may include network interface circuitry 1507 (also referred to as a network interface, e.g., corresponding to portions of communication interface 2506 of FIG. 25) configured to provide communications with other nodes (e.g., with other base stations) of the RAN and/or core network CN. The network node 1500 may also include processing circuitry 1503 (also referred to as a processor, e.g., corresponding to processing circuitry 2502 of FIG. 25) coupled to the transceiver circuitry, and memory circuitry 1505 (also referred to as memory, e.g., corresponding to memory 2504 of FIG. 25) coupled to the processing circuitry. The memory circuitry 1505 may include computer readable program code that when executed by the processing circuitry 1503 causes the processing circuitry to perform operations according to embodiments disclosed herein. According to other embodiments, processing circuitry 1503 may be defined to include memory so that a separate memory circuitry is not required.

As discussed herein, operations of the SN 1500 may be performed by processing circuitry 1503, network interface 1507, and/or transceiver 1501. For example, processing circuitry 1503 may control transceiver 1501 to transmit downlink communications through transceiver 1501 over a radio interface to one or more mobile terminals UEs and/or to receive uplink communications through transceiver 1501 from one or more mobile terminals UEs over a radio interface. Similarly, processing circuitry 1503 may control network interface 1507 to transmit communications through network interface 1507 to one or more other network nodes and/or to receive communications through network interface from one or more other network nodes. Moreover, modules may be stored in memory 1505, and these modules may provide instructions so that when instructions of a module are executed by processing circuitry 1503, processing circuitry 1503 performs respective operations (e.g., operations discussed below with respect to Example Embodiments relating to secondary nodes). According to some embodiments, SN 1500 and/or an element(s)/function(s) thereof may be embodied as a virtual node/nodes and/or a virtual machine/machines.

FIG. 16 is a block diagram illustrating elements of a master node 1600 (also referred to as a MN, a network node, base station, eNodeB/eNB, gNodeB/gNB, etc.) of a Radio Access Network (RAN) configured to provide cellular communication according to embodiments of inventive concepts. (Master node 1600 may be provided, for example, as discussed below with respect to network node 2310A, 2310B of FIG. 23, network node 2500 of FIG. 25, hardware 2704 or virtual machine 2708A, 2708B of FIG. 27, and/or base station 2804 of FIG. 28, all of which should be considered interchangeable in the examples and embodiments described herein and be within the intended scope of this disclosure, unless otherwise noted.) As shown, the MN 1600 may include transceiver circuitry 1601 (also referred to as a transceiver, e.g., corresponding to portions of RF transceiver circuitry 2512 and radio front end circuitry 2518 of FIG. 25) including a transmitter and a receiver configured to provide uplink and downlink radio communications with mobile terminals. The MN 1600 may include network interface circuitry 1607 (also referred to as a network interface, e.g., corresponding to portions of communication interface 2506 of FIG. 25) configured to provide communications with other nodes (e.g., with other base stations) of the RAN and/or core network CN. The network node may also include processing circuitry 1603 (also referred to as a processor, e.g., corresponding to processing circuitry 2502 of FIG. 25) coupled to the transceiver circuitry, and memory circuitry 1605 (also referred to as memory, e.g., corresponding to memory 2504 of FIG. 25) coupled to the processing circuitry. The memory circuitry 1605 may include computer readable program code that when executed by the processing circuitry 1603 causes the processing circuitry to perform operations according to embodiments disclosed herein. According to other embodiments, processing circuitry 1603 may be defined to include memory so that a separate memory circuitry is not required.

As discussed herein, operations of the MN 704 may be performed by processing circuitry 1603, network interface 1607, and/or transceiver 1601. For example, processing circuitry 1603 may control transceiver 1601 to transmit downlink communications through transceiver 1601 over a radio interface to one or more mobile terminals UEs and/or to receive uplink communications through transceiver 1601 from one or more mobile terminals UEs over a radio interface. Similarly, processing circuitry 1603 may control network interface 1607 to transmit communications through network interface 1607 to one or more other network nodes and/or to receive communications through network interface from one or more other network nodes. Moreover, modules may be stored in memory 1605, and these modules may provide instructions so that when instructions of a module are executed by processing circuitry 1603, processing circuitry 1603 performs respective operations (e.g., operations discussed below with respect to Example Embodiments relating to master nodes). According to some embodiments, MN 1600 and/or an element(s)/function(s) thereof may be embodied as a virtual node/nodes and/or a virtual machine/machines.

Various embodiments of inventive concepts of methods are provided for a UE configured in dual connectivity, such as Multi-Radio Dual Connectivity (e.g. MR-DC), with a Master Cell Group (MCG), controlled by a Master Node (MN) and a Secondary Cell Group (SCG), controlled by a Secondary Node (SN). The MCG may contain multiple cells such as one Primary Cell (PCell) and optionally one or several Secondary Cells (SCells). The SCG may as well contain multiple cells such as one Primary SCG Cell (PSCell) and optionally one or several Secondary Cells (SCells). The PCell and PSCell are sometimes also referred to as SpCells, for the MCG and SCG respectively.

The various embodiments use terms like SCG and PSCell, as one of the cells associated with the SCG. That can be for example a PSCell as defined in NR specifications (e.g. RRC TS 38.331), defined as a Special Cell (SpCell) of the SCG, or a Primary SCG Cell (PSCell), as follows:
Secondary Cell Group: For a UE configured with dual connectivity, the subset of serving cells comprising of the PSCell and zero or more secondary cells (SCells).
Special Cell: For Dual Connectivity operation the term Special Cell refers to the PCell of the MCG or the PSCell of the SCG, otherwise the term Special Cell refers to the PCell.
Primary SCG Cell (PSCell): For dual connectivity operation, the SCG cell in which the UE performs random access when performing the Reconfiguration with Sync procedure

FIG. 12 illustrates various nodes that may be used in implementing various inventive concepts. These various nodes include:
UE A User Equipment configured in dual connectivity, such as Multi-Radio Dual Connectivity (e.g. MR-DC). The UE is connected with the MN over the Uu interface in the MCG and to the SN over the Uu interface in the SCG.
MCG The Master Cell Group is the subset of the serving cells (either NR cells or LTE cells) used by the UE, comprising of the PCell and zero or more secondary cells (SCells).
SCG The Secondary Cell Group is the subset of serving cells (either NR cells or LTE cells) used by the UE, comprising of the PSCell and zero or more secondary cells (SCells).
MN The Master Node controls the cells in the MCG used by the UE and in case of NR cells it is a gNB. The MN is connected to the SN using an interface, and for 5G NR this interface is defined as the Xn interface. The MN is also connected to the core network, for 5G the core network is known as 5GC and the interface is known as NG. The MN has the overall control of the RRC connection for the UE.
SN The Secondary Node controls the cells in the SCG used by the UE and in case of controlling NR cells it is a gNB. The SN is connected to the MN using an interface, and for 5G NR this interface is defined as the Xn interface. The SN is also connected to the core network, for 5G the core network is known as 5GC and the interface is known as NG.

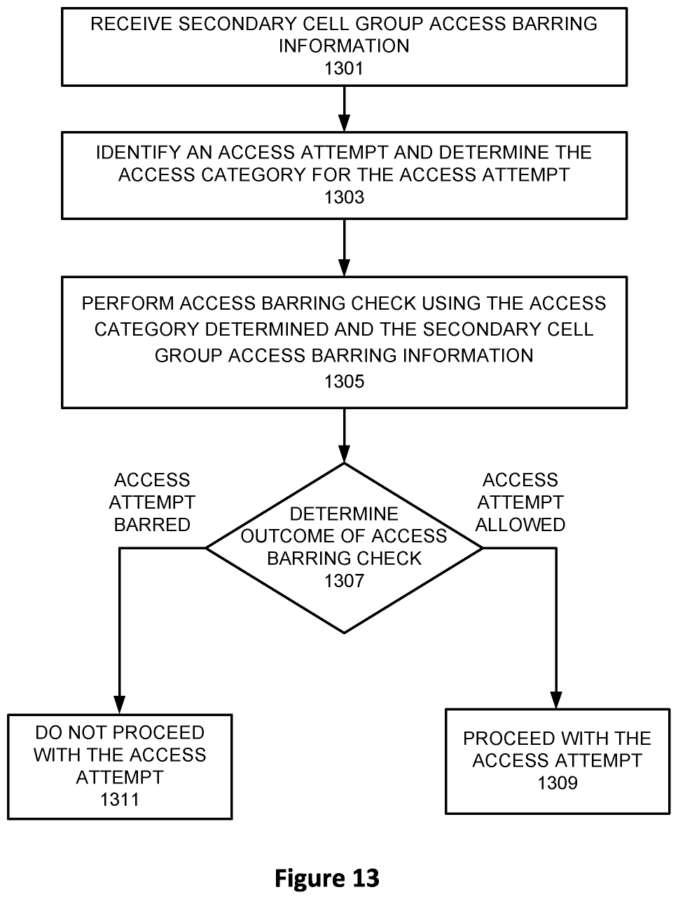

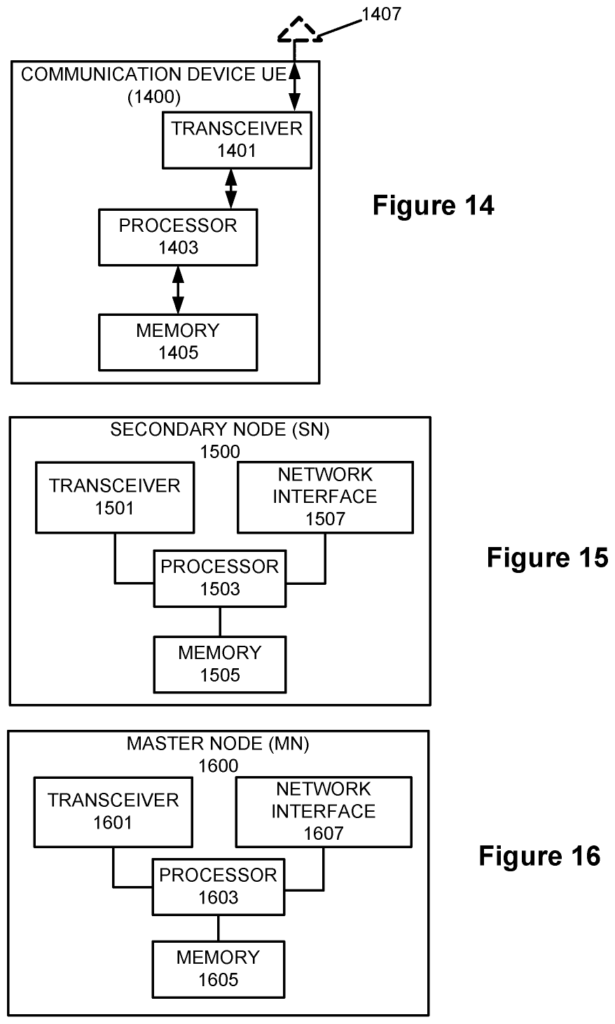

In the description that follows, while the communication device may be any of the wireless communication device 1400, wireless device 2312A, 2312B, wired or wireless devices UE 2312C, UE 2312D, UE 2400, virtualization hardware 2704, virtual machines 2708A, 2708B, or UE 2806, the wireless communication device 1400 shall be used to describe the functionality of the operations of the communication device. Operations of the wireless communication device 1400 (implemented using the structure of the block diagram of FIG. 14) will now be discussed with reference to the flow chart of FIG. 13 according to some embodiments of inventive concepts. For example, modules may be stored in memory 1405 of FIG. 14, and these modules may provide instructions so that when the instructions of a module are executed by respective communication device processing circuitry 1403, processing circuitry 1403 performs respective operations of the flow chart.

FIG. 13 illustrates operations a wireless communication device 1400 performs in one embodiment of inventive concepts. Turning to FIG. 13, in block 1301. the processing circuitry 1403 receives secondary cell group (SCG) access barring information. The SCG access barring information may be Unified Access Control barring information, containing a barring factor associated with each access category for which barring are applied. In one example, this SCG access barring information is received with RRC dedicated signalling from the MN, such as an RRCReconfiguration message on SRB1. In another example, the SCG access barring information is received with system information transmitted from the SN, for example in broadcasted system information in the PSCell.

In block 1303, the processing circuitry 1403 identifies an access attempt and determines the access category for the access attempt. In one example, the UE determines also whether the access attempt will use the SCG access barring information or the MCG access barring information. In one example, this determination is based on the type of access attempt, for example, if the type of access attempt belongs to a set of access attempts which use the SCG access barring information (as stated in the specification or configured by the network). In another example, this determination is based on the determined access category for the access attempt, for example if the determined access category belongs to a set of access categories which use the SCG access barring information (as stated in the specification or configured by the network).

In block 1305, the processing circuitry 1403 performs an access barring check for the access attempt using determined access category and the received secondary cell group access barring information. In one example, when the UE have determined that the access attempt will use the SCG access barring information in step 1303, the UE performs the access barring check using the SCG access barring information.

In block 1307, the processing circuitry 1403 checks the outcome of the access barring check. If the outcome of the access barring check is that the access attempt is allowed, the UE goes to step 1309, otherwise the access attempt is barred and the UE goes to step 1311.

In block 1309, the processing circuitry 1403, if the access attempt is allowed, the processing circuitry 1403 proceeds with the access attempt, such as accessing the network using the SCG according to the origination of the access attempt.

In block 1311, the processing circuitry 1403, if the access attempt is barred, the processing circuitry 1403 does not proceed with the access attempt.

In one example, an access attempt which will use the SCG access barring information is UE-triggered or network-triggered SCG activation, which may be performed by a random access procedure or a scheduling request in the PSCell. Another example of an access attempt which will use the SCG access barring information is a MCG failure recovery procedure. In another example, access attempts which concerns the SCG (including those examples of attempts above) are mapped onto a certain set of access categories. This may be new access categories or existing categories. For example, when the UE identifies an access attempt, it maps the access attempt onto one of the existing access categories and access identities. During the access barring check, the UE 1400 then applies either the SCG barring information or the MCG barring information depending on the type of access attempt.

In one example, a UE-triggered SCG activation may be mapped onto access category 7 (MO data) and uses the SCG access barring information during the access barring check.

In another example, at network-triggered SCG activation, the MN transmits an RRC message (such as an RRCReconfiguration message) with the instruction to the UE to activate the SCG, but the MN may not be aware of the SCG access barring information and that some access categories may be barred. The network triggered SCG activation may be mapped onto access category 7 (MO data) and the UE uses the SCG access barring information during the access barring check to determine whether the network-triggered SCG activation is barred or not.

In another example, an MCG failure recovery procedure may be mapped onto access category 8 (MO signalling on RRC level) and uses the SCG access barring information during the access barring check.

In yet another example, the access attempt is mapped onto an operator-defined access category. For example, the MCG and SCG use different network slices and the mapping onto the operator-defined access category is performed with the corresponding slice id (S-NSSAI) as criteria. For example, an access attempt relating to the SCG will use one S-NSSAI value and based on a criteria configured in the UE by the network, this access attempt is mapped onto the appropriate operator-defined access category.

### Service Barred on PCell but Allowed on PSCell

In an alternative embodiment, a UE in RRC_CONNECTED that is about to initiate setup of a new service/session, e.g., corresponding to an access category for which the UE does not currently have any service/session established, determines that access for this access category (and access identity) is barred for the UE in the PCell. The UE then also checks access barring in the serving PSCell for the access category (and access identity) and determines that access for the corresponding service/session is not barred in the PSCell. In one alternative the UE is then allowed to initiate setup of the service/session even though it is barred for the UE in the PCell. In one example, the network provides the UE with an indication or configuration whether it is allowed to initiate a setup of the service/session in this specific case. In another example, the UE is only allowed to initiate the setup of the service/session if the network indicates support for SCG only bearers, i.e. data radio bearers with resources only in the SCG. In another example, when the UE is about the setup a new service/session that uses only SCG bearers, the access attempt is allowed even if the service is barred in the PCell and not in the PSCell. In this example, during the setup of the new service (session, the MN accepts the request from the core network to setup the user plane resources even if the MN applies barring in the PCell in case the user plane resources does not require any MCG or split bearers, only SCG bearers. In this example, the UE uses the SCG access barring information in the access barring check to determine whether the setup of SCG bearer is barred or not.

In another alternative, the UE may initiate setup of the service/session even though it is barred for the UE in the PCell, but not barred in the PSCell, and indicates to the network that the new session is barred in the PCell/MCG but allowed in the PSCell/SCG so that the session is setup there, e.g. using an SCG bearer or a split bearer with a configuration leading to that only (or mainly) the SCG is used for the data transfers.

### Service Barred on PSCell but Allowed on PCell

In another alternative embodiment, a UE in RRC_CONNECTED that is to initiate setup of a new service/session, e.g., corresponding to an access category for which the UE does not currently have any service/session established, determines that access for this access category (and access identity) is allowed for the UE in the PCell but that it is barred for the UE in the PSCell. The UE then indicates to the network, e.g., through signaling to or via the PCell/MCG, that the service/session is barred for the UE in the PSCell/SCG. The network can then configure the session so that no resources are used in the PSCell, e.g., using an MCG bearer or a split bearer with a configuration leading to that only (or mainly) the MCG is used for the data transfers.

### Access Barring Check for PSCell at RRC Resume

In one embodiment the Unified Access Control, including e.g., the access barring checks, for the PSCell is used also when the UE is to resume from RRC_INACTIVE to RRC_CONNECTED. This could, for example, be done when the UE has a stored SCG configuration while in RRC_INACTIVE and it then checks the system information for the corresponding stored PSCell to check the access barring there. The UE can then determine access barring for both the PCell and for the PSCell for which it has a stored configuration while in RRC_INACTIVE, when it is to initiate an RRC Resume procedure to transition to RRC_CONNECTED. As in the above embodiments the UE then indicates to the network whether the service/session that is to be setup is barred in the PCell or in the PSCell (or if it is allowed or barred in both). This indication could then be provided to the network during the RRC Resume procedure, such as, for example, through the RRC Resume Request message or in another message that is sent during or after the procedure.

### Provisioning of SCG Access Barring Information to the UE

In one alternative, this SCG access barring information is provided with RRC dedicated signalling from the MN to the UE, such as in an RRCReconfiguration message on SRB1. For example, during SCG activation or deactivation, the SN provides the SCG access barring information to the MN, which then forwards it in the RRC message instructing the UE to perform SCG activation or deactivation.

In another alternative, the SCG access barring information is provided by system information transmitted from the SN to the UE, for example in broadcasted system information in the PSCell, such as in the System Information Block 1 (SIB1). In this alternative, the UE uses as SCG access barring information the same access barring information that is broadcasted in SIB1 used by also UEs which using the particular cell as the PCell of an MCG. In this alternative, when the UE identified an access attempt which would use the SCG access barring information in the access barring check, it first checks the applicable system information (such as in SIB1) in the cell which happens to be the PSCell for the access barring information.

In another alternative, the SCG access barring information is provided by system information but is separated from the access barring information intended for the UEs which using the particular cell as the PCell of an MCG. In order words, the SCG access barring information is only used by UEs using the particular cell as the PSCell of an SCG. Below an example implementation in the NR or LTE RRC specification of this alternative is given. In this example, the SCG access barring information is included in new fields uac-BarringForCommonSCG and uac-BarringPerPLMN-ListSCG within IE uac-BarringInfo sent in SIB1.

| | |
|---|---|
| uac-BarringInfo | SEQUENCE { |
| uac-BarringForCommon | UAC-BarringPerCatList OPTIONAL, -- Need S |
| uac-BarringPerPLMN-List | OPTIONAL, -- Need S |
| uac-BarringForCommonSCG | UAC-BarringPerCatList OPTIONAL, -- Need S |
| uac-BarringPerPLMN-ListSCG | UAC-BarringPerPLMN-List OPTIONAL, -- Need S |

```
  uac-BarringInfoSetList ,
  uac-AccessCategory1-SelectionAssistanceInfo CHOICE {
```

| | |
|---|---|
| plmnCommon | UAC-AccessCategory1-SelectionAssistanceInfo, |
| individualPLMNList | SEQUENCE (SIZE (2..maxPLMN)) OF UAC- |

AccessCategory1-SelectionAssistanceInfo
}

In the above example, the new fields uac-BarringForCommonSCG and uac-BarringPerPLMN-ListSCG are only used by UEs using the particular cell as the PSCell of an SCG. The UEs which are using the particular cell as the PCell of an MCG use instead the uac-BarringForCommon and uac-BarringPerPLMN-List as access barring information.

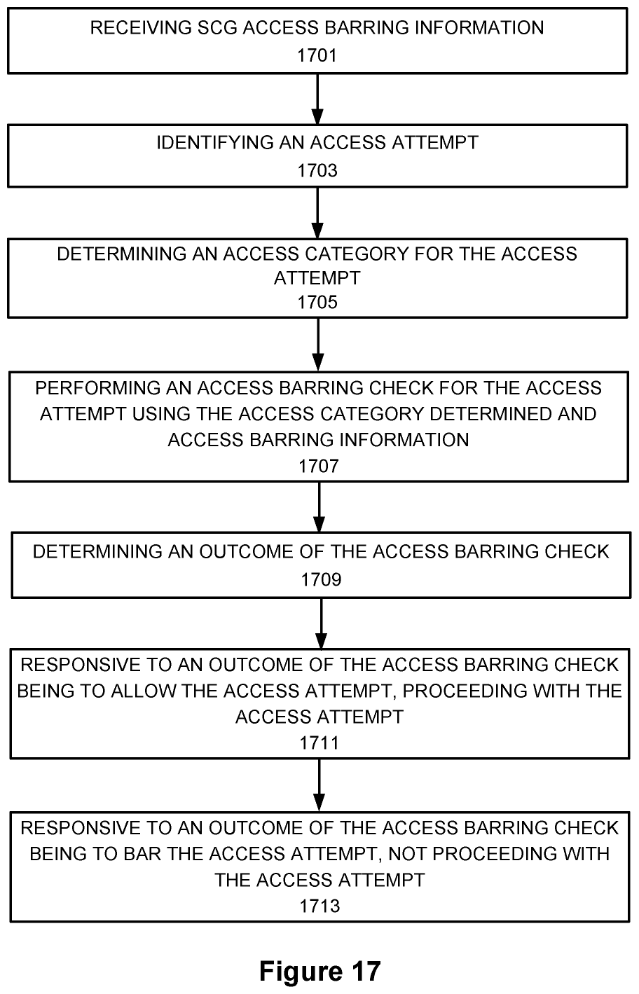

FIG. 17 illustrates operations a UE performs in another embodiment of inventive concepts. Similar to FIG. 13, the wireless communication device 1400 shall be used to describe the functionality of the operations of the communication device. Operations of the wireless communication device 1400 (implemented using the structure of the block diagram of FIG. 14) will now be discussed with reference to the flow chart of FIG. 17 according to some embodiments of inventive concepts.

Turning to FIG. 17, in block 1701, the processing circuitry 1403 receives SCG access barring information. The processing circuitry 1403 may receive unified access control barring information in some embodiments. As indicated above, the unified access control barring information may contain barring factor associated with each access category for which barring are applied.

In some embodiments, the processing circuitry 1403 receives the SCG access barring information via dedicated radio resource control, RRC, signalling from the MN. In other embodiments, the processing circuitry 1403 receives the SCG access barring information via system information transmitted from the SN.

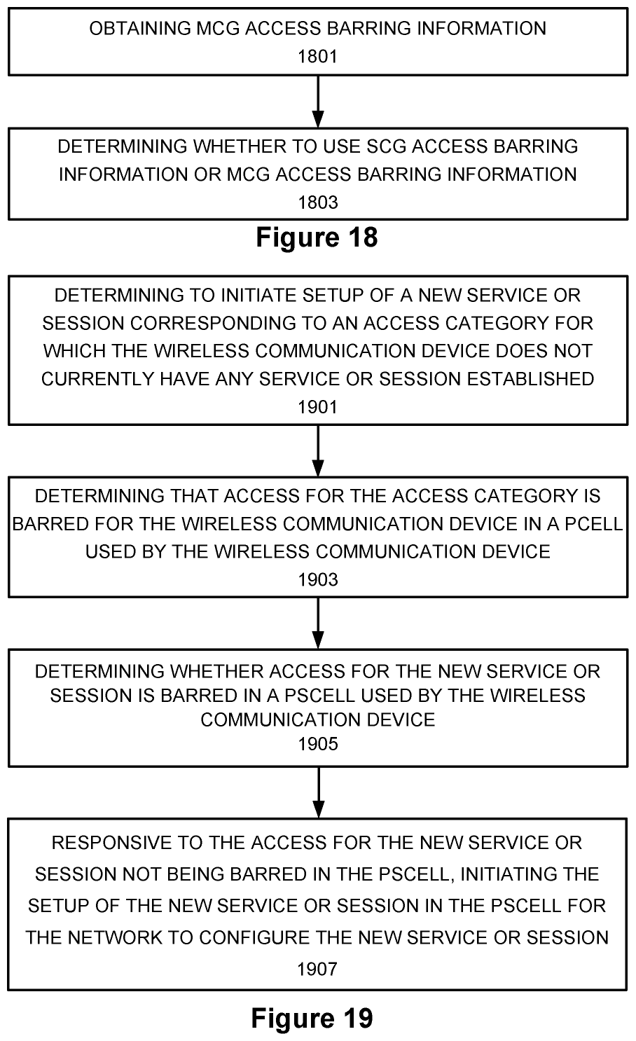

In further embodiments as illustrated in FIG. 18, the processing circuitry 1403 in block 1801 obtains MCG access barring information. The processing circuitry 1403 in block 1803 determines whether to use the SCG access barring information or the MCG access barring information in the access attempt.

Returning to FIG. 17, in block 1703, the processing circuitry 1403 identifies an access attempt. In block 1705, the processing circuitry 1403 determines an access category for the access attempt. In some embodiments, the processing circuitry 1403 determines also whether the access attempt will use the SCG access barring information or the MCG access barring information. In some embodiments, this determination is based on the type of access attempt, for example, if the type of access attempt belongs to a set of access attempts which use the SCG access barring information (as stated in the specification or configured by the network). In another embodiment, this determination is based on the determined access category for the access attempt, for example if the determined access category belongs to a set of access categories which use the SCG access barring information (as stated in the specification or configured by the network). In other embodiments, the processing circuitry 1403 identifies the access attempt by mapping the access attempt onto one of existing access categories and access identities.

In block 1707, the processing circuitry 1403 performs an access barring check for the access attempt using the access category determined and access barring information. In some embodiments, the processing circuitry 1403 performs the access barring check by applying MCG access barring information or SCG access barring information based on a type of the access attempt. For example, when the processing circuitry 1403 has determined that the access attempt will use the SCG access barring information, the processing circuitry 1403 performs the access barring check using the SCG access barring information. In some embodiments where the access barring information is SCG access barring information, the processing circuitry 1403 uses the SCG access barring information to determine whether network-triggered SCG activation is barred in performing the access barring check.

In block 1709, the processing circuitry 1403 determines the outcome of the access barring check. The processing circuitry 1403, responsive to an outcome of the access barring check being to allow the access attempt, proceeds with the access attempt in block 1711. The processing circuitry 1403, responsive to an outcome of the access barring check being to bar the access attempt, does not proceed with the access attempt in block 1711.

In some embodiments, service is barred in the PCell used by the wireless communication device 1400 but is allowed on the PSCell used by the wireless communication device 1400. FIG. 19 illustrates operations the wireless communication device 1400 performs in some of these embodiments.

Turning to FIG. 19, in block 1901, the processing circuitry 1403 determines to initiate setup of a new service or session corresponding to an access category for which the wireless communication device does not currently have any service or session established. In block 1903, the processing circuitry 1403 determines that access for the access category is barred for the wireless communication device 1400 in a PCell used by the wireless communication device 1400.

In block 1905, the processing circuitry 1403 determines whether access for the new service or session is barred in a PSCell used by the wireless communication device 1400. Responsive to the access for the new service or session not being barred in the PSCell, the processing circuitry 1403 in block 1907 initiates the setup of the new service or session in the PSCell.

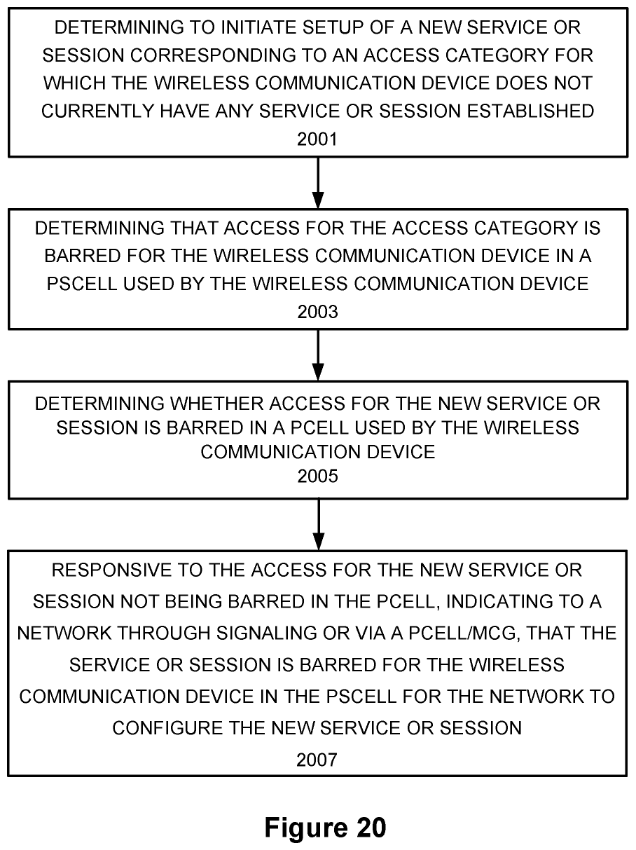

In some embodiments, service is barred in the PSCell used by the wireless communication device 1400 but is allowed on the PCell used by the wireless communication device 1400. FIG. 20 illustrates operations the wireless communication device 1400 performs in some of these embodiments.

Turning to FIG. 20, in block 2001, the processing circuitry 1403 determines to initiate setup of a new service or session corresponding to an access category for which the wireless communication device does not currently have any service or session established. In block 2003, the processing circuitry 1403 determines that access for the access category is barred for the wireless communication device 1400 in a PSCell used by the wireless communication device 1400.

In block 2005, the processing circuitry 1403 determines whether access for the new service or session is barred in a PCell used by the wireless communication device 1400. Responsive to the access for the new service or session not being barred in the PCell, the processing circuitry 1403 in block 2007 indicates to a network through signaling or via a PCell/MCG, that the service or session is barred for the wireless communication device in the PSCell of the wireless communication device for the network to configure the new service or session.

Various operations from the flow chart of FIG. 17 may be optional with respect to some embodiments of wireless communication devices and related methods. Regarding methods of example embodiment 1 (set forth below), for example, operations of blocks 1709, 1711, and 1713 of FIG. 17 may be optional.

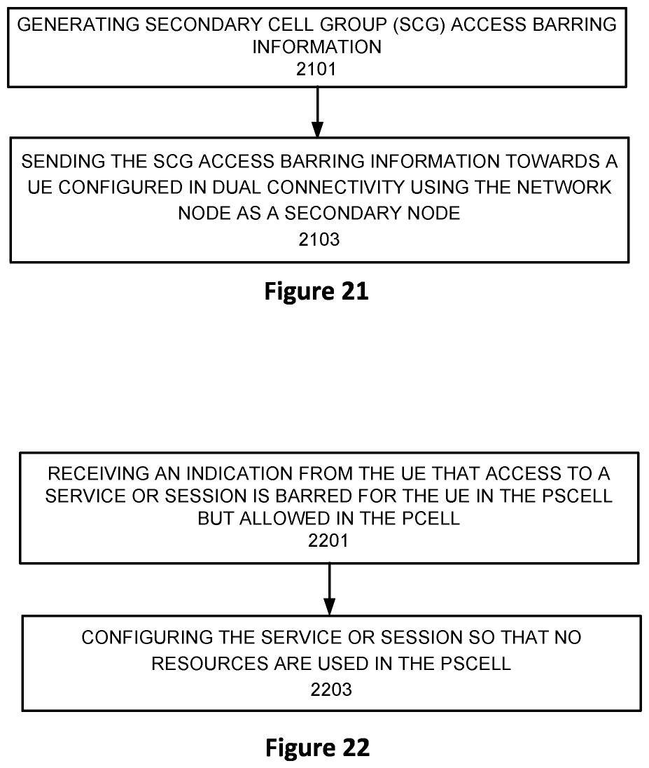

In the description that follows, while the secondary node may be any of the secondary node 1500, network node 2310A, 2310B, 2500, 2806, hardware 2704, or virtual machine 2708A, 2708B, the secondary node 1500 shall be used to describe the functionality of the operations of the network node. Operations of the secondary node 1500 (implemented using the structure of FIG. 15) will now be discussed with reference to the flow chart of FIG. 21 according to some embodiments of inventive concepts. For example, modules may be stored in memory 1505 of FIG. 15, and these modules may provide instructions so that when the instructions of a module are executed by respective secondary node processing circuitry 1503, processing circuitry 1503 performs respective operations of the flow chart.

Turning to FIG. 21, in block 2101, the processing circuitry 1503 generates secondary cell group (SCG) access barring information. In block 2103, the processing circuitry 1503 sends the SCG access barring information towards a user equipment, UE, configured in dual connectivity using the network node as a secondary node, SN. In some embodiments, the processing circuitry 103 sends the SCG access barring information towards the UE by providing the SCG access barring information in system information transmitted from the network node to the UE. In some of these embodiments, the processing circuitry 1503 provides the SCG access barring information in system information transmitted from the network node to the UE by broadcasting the system information only to UEs using a current cell as a PSCell of the SCG.

In some embodiments of inventive concepts, the network node may aide a wireless communication device 1400 in configuring a service or session. FIG. 22 illustrates an embodiment of this.

Turning to FIG. 22, in block 2201, the processing circuitry 1503 receives an indication from the UE that access to a service or session is barred for the UE in the PSCell but allowed in the PCell. In block 2203, the processing circuitry 1503 configures the service or session so that no resources are used in the PSCell.

FIG. 23 shows an example of a communication system 2300 in accordance with some embodiments.

In the example, the communication system 2300 includes a telecommunication network 2302 that includes an access network 2304, such as a radio access network (RAN), and a core network 2306, which includes one or more core network nodes 2308. The access network 2304 includes one or more access network nodes, such as network nodes 2310a and 2310b (one or more of which may be generally referred to as network nodes 2310), or any other similar 3rd Generation Partnership Project (3GPP) access node or non-3GPP access point. The network nodes 2310 facilitate direct or indirect connection of user equipment (UE), such as by connecting UEs 2312a, 2312b, 2312c, and 2312d (one or more of which may be generally referred to as UEs 2312) to the core network 2306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2300 may include any number of wired or wireless networks, network nodes, UEs, and/or any other components or systems that may facilitate or participate in the communication of data and/or signals whether via wired or wireless connections. The communication system 2300 may include and/or interface with any type of communication, telecommunication, data, cellular, radio network, and/or other similar type of system.

The UEs 2312 may be any of a wide variety of communication devices, including wireless devices arranged, configured, and/or operable to communicate wirelessly with the network nodes 2310 and other communication devices. Similarly, the network nodes 2310 are arranged, capable, configured, and/or operable to communicate directly or indirectly with the UEs 2312 and/or with other network nodes or equipment in the telecommunication network 2302 to enable and/or provide network access, such as wireless network access, and/or to perform other functions, such as administration in the telecommunication network 2302.

In the depicted example, the core network 2306 connects the network nodes 2310 to one or more hosts, such as host 2316. These connections may be direct or indirect via one or more intermediary networks or devices. In other examples, network nodes may be directly coupled to hosts. The core network 2306 includes one more core network nodes (e.g., core network node 2308) that are structured with hardware and software components. Features of these components may be substantially similar to those described with respect to the UEs, network nodes, and/or hosts, such that the descriptions thereof are generally applicable to the corresponding components of the core network node 2308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2316 may be under the ownership or control of a service provider other than an operator or provider of the access network 2304 and/or the telecommunication network 2302, and may be operated by the service provider or on behalf of the service provider. The host 2316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2300 of FIG. 23 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2302 is a cellular network that implements 3GPP standardized features. Accordingly, the telecommunications network 2302 may support network slicing to provide different logical networks to different devices that are connected to the telecommunication network 2302. For example, the telecommunications network 2302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2312 are configured to transmit and/or receive information without direct human interaction. For instance, a UE may be designed to transmit information to the access network 2304 on a predetermined schedule, when triggered by an internal or external event, or in response to requests from the access network 2304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2314 communicates with the access network 2304 to facilitate indirect communication between one or more UEs (e.g., UE 2312c and/or 2312d) and network nodes (e.g., network node 2310b). In some examples, the hub 2314 may be a controller, router, content source and analytics, or any of the other communication devices described herein regarding UEs. For example, the hub 2314 may be a broadband router enabling access to the core network 2306 for the UEs. As another example, the hub 2314 may be a controller that sends commands or instructions to one or more actuators in the UEs. Commands or instructions may be received from the UEs, network nodes 2310, or by executable code, script, process, or other instructions in the hub 2314. As another example, the hub 2314 may be a data collector that acts as temporary storage for UE data and, in some embodiments, may perform analysis or other processing of the data. As another example, the hub 2314 may be a content source. For example, for a UE that is a VR headset, display, loudspeaker or other media delivery device, the hub 2314 may retrieve VR assets, video, audio, or other media or data related to sensory information via a network node, which the hub 2314 then provides to the UE either directly, after performing local processing, and/or after adding additional local content. In still another example, the hub 2314 acts as a proxy server or orchestrator for the UEs, in particular in if one or more of the UEs are low energy IoT devices.

The hub 2314 may have a constant/persistent or intermittent connection to the network node 2310b. The hub 2314 may also allow for a different communication scheme and/or schedule between the hub 2314 and UEs (e.g., UE 2312c and/or 2312d), and between the hub 2314 and the core network 2306. In other examples, the hub 2314 is connected to the core network 2306 and/or one or more UEs via a wired connection. Moreover, the hub 2314 may be configured to connect to an M2M service provider over the access network 2304 and/or to another UE over a direct connection. In some scenarios, UEs may establish a wireless connection with the network nodes 2310 while still connected via the hub 2314 via a wired or wireless connection. In some embodiments, the hub 2314 may be a dedicated hub—that is, a hub whose primary function is to route communications to/from the UEs from/to the network node 2310b. In other embodiments, the hub 2314 may be a non-dedicated hub—that is, a device which is capable of operating to route communications between the UEs and network node 2310b, but which is additionally capable of operating as a communication start and/or end point for certain data channels.

FIG. 24 shows a UE 2400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2400 includes processing circuitry 2402 that is operatively coupled via a bus 2404 to an input/output interface 2406, a power source 2408, a memory 2410, a communication interface 2412, and/or any other component, or any combination thereof. Certain UEs may utilize all or a subset of the components shown in FIG. 24. The level of integration between the components may vary from one UE to another UE. Further, certain UEs may contain multiple instances of a component, such as multiple processors, memories, transceivers, transmitters, receivers, etc.

The processing circuitry 2402 is configured to process instructions and data and may be configured to implement any sequential state machine operative to execute instructions stored as machine-readable computer programs in the memory 2410. The processing circuitry 2402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2402 may include multiple central processing units (CPUs).

In the example, the input/output interface 2406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2408 is structured as a battery or battery pack. Other types of power sources, such as an external power source (e.g., an electricity outlet), photovoltaic device, or power cell, may be used. The power source 2408 may further include power circuitry for delivering power from the power source 2408 itself, and/or an external power source, to the various parts of the UE 2400 via input circuitry or an interface such as an electrical power cable. Delivering power may be, for example, for charging of the power source 2408. Power circuitry may perform any formatting, converting, or other modification to the power from the power source 2408 to make the power suitable for the respective components of the UE 2400 to which power is supplied.

The memory 2410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2410 includes one or more application programs 2414, such as an operating system, web browser application, a widget, gadget engine, or other application, and corresponding data 2416. The memory 2410 may store, for use by the UE 2400, any of a variety of various operating systems or combinations of operating systems.

The memory 2410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2410 may allow the UE 2400 to access instructions, application programs and the like, stored on transitory or non-transitory memory media, to off-load data, or to upload data. An article of manufacture, such as one utilizing a communication system may be tangibly embodied as or in the memory 2410, which may be or comprise a device-readable storage medium.

The processing circuitry 2402 may be configured to communicate with an access network or other network using the communication interface 2412. The communication interface 2412 may comprise one or more communication subsystems and may include or be communicatively coupled to an antenna 2422. The communication interface 2412 may include one or more transceivers used to communicate, such as by communicating with one or more remote transceivers of another device capable of wireless communication (e.g., another UE or a network node in an access network). Each transceiver may include a transmitter 2418 and/or a receiver 2420 appropriate to provide network communications (e.g., optical, electrical, frequency allocations, and so forth). Moreover, the transmitter 2418 and receiver 2420 may be coupled to one or more antennas (e.g., antenna 2422) and may share circuit components, software or firmware, or alternatively be implemented separately.

In the illustrated embodiment, communication functions of the communication interface 2412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2400 shown in FIG. 24.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 25 shows a network node 2500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2500 includes a processing circuitry 2502, a memory 2504, a communication interface 2506, and a power source 2508. The network node 2500 may be composed of multiple physically separate components (e.g., a NodeB component and a RNC component, or a BTS component and a BSC component, etc.), which may each have their own respective components. In certain scenarios in which the network node 2500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2500 may be configured to support multiple radio access technologies (RATs). In such embodiments, some components may be duplicated (e.g., separate memory 2504 for different RATs) and some components may be reused (e.g., a same antenna 2510 may be shared by different RATs). The network node 2500 may also include multiple sets of the various illustrated components for different wireless technologies integrated into network node 2500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2500.

The processing circuitry 2502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2500 components, such as the memory 2504, to provide network node 2500 functionality.

In some embodiments, the processing circuitry 2502 includes a system on a chip (SOC). In some embodiments, the processing circuitry 2502 includes one or more of radio frequency (RF) transceiver circuitry 2512 and baseband processing circuitry 2514. In some embodiments, the radio frequency (RF) transceiver circuitry 2512 and the baseband processing circuitry 2514 may be on separate chips (or sets of chips), boards, or units, such as radio units and digital units. In alternative embodiments, part or all of RF transceiver circuitry 2512 and baseband processing circuitry 2514 may be on the same chip or set of chips, boards, or units.

The memory 2504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2502. The memory 2504 may store any suitable instructions, data, or information, including a computer program, software, an application including one or more of logic, rules, code, tables, and/or other instructions capable of being executed by the processing circuitry 2502 and utilized by the network node 2500. The memory 2504 may be used to store any calculations made by the processing circuitry 2502 and/or any data received via the communication interface 2506. In some embodiments, the processing circuitry 2502 and memory 2504 is integrated.

The communication interface 2506 is used in wired or wireless communication of signaling and/or data between a network node, access network, and/or UE. As illustrated, the communication interface 2506 comprises port(s)/terminal(s) 2516 to send and receive data, for example to and from a network over a wired connection. The communication interface 2506 also includes radio front-end circuitry 2518 that may be coupled to, or in certain embodiments a part of, the antenna 2510. Radio front-end circuitry 2518 comprises filters 2520 and amplifiers 2522. The radio front-end circuitry 2518 may be connected to an antenna 2510 and processing circuitry 2502. The radio front-end circuitry may be configured to condition signals communicated between antenna 2510 and processing circuitry 2502. The radio front-end circuitry 2518 may receive digital data that is to be sent out to other network nodes or UEs via a wireless connection. The radio front-end circuitry 2518 may convert the digital data into a radio signal having the appropriate channel and bandwidth parameters using a combination of filters 2520 and/or amplifiers 2522. The radio signal may then be transmitted via the antenna 2510. Similarly, when receiving data, the antenna 2510 may collect radio signals which are then converted into digital data by the radio front-end circuitry 2518. The digital data may be passed to the processing circuitry 2502. In other embodiments, the communication interface may comprise different components and/or different combinations of components.

In certain alternative embodiments, the network node 2500 does not include separate radio front-end circuitry 2518, instead, the processing circuitry 2502 includes radio front-end circuitry and is connected to the antenna 2510. Similarly, in some embodiments, all or some of the RF transceiver circuitry 2512 is part of the communication interface 2506. In still other embodiments, the communication interface 2506 includes one or more ports or terminals 2516, the radio front-end circuitry 2518, and the RF transceiver circuitry 2512, as part of a radio unit (not shown), and the communication interface 2506 communicates with the baseband processing circuitry 2514, which is part of a digital unit (not shown).

The antenna 2510 may include one or more antennas, or antenna arrays, configured to send and/or receive wireless signals. The antenna 2510 may be coupled to the radio front-end circuitry 2518 and may be any type of antenna capable of transmitting and receiving data and/or signals wirelessly. In certain embodiments, the antenna 2510 is separate from the network node 2500 and connectable to the network node 2500 through an interface or port.

The antenna 2510, communication interface 2506, and/or the processing circuitry 2502 may be configured to perform any receiving operations and/or certain obtaining operations described herein as being performed by the network node. Any information, data and/or signals may be received from a UE, another network node and/or any other network equipment. Similarly, the antenna 2510, the communication interface 2506, and/or the processing circuitry 2502 may be configured to perform any transmitting operations described herein as being performed by the network node. Any information, data and/or signals may be transmitted to a UE, another network node and/or any other network equipment.

The power source 2508 provides power to the various components of network node 2500 in a form suitable for the respective components (e.g., at a voltage and current level needed for each respective component). The power source 2508 may further comprise, or be coupled to, power management circuitry to supply the components of the network node 2500 with power for performing the functionality described herein. For example, the network node 2500 may be connectable to an external power source (e.g., the power grid, an electricity outlet) via an input circuitry or interface such as an electrical cable, whereby the external power source supplies power to power circuitry of the power source 2508. As a further example, the power source 2508 may comprise a source of power in the form of a battery or battery pack which is connected to, or integrated in, power circuitry. The battery may provide backup power should the external power source fail.

Embodiments of the network node 2500 may include additional components beyond those shown in FIG. 25 for providing certain aspects of the network node's functionality, including any of the functionality described herein and/or any functionality necessary to support the subject matter described herein. For example, the network node 2500 may include user interface equipment to allow input of information into the network node 2500 and to allow output of information from the network node 2500. This may allow a user to perform diagnostic, maintenance, repair, and other administrative functions for the network node 2500.

FIG. 26 is a block diagram of a host 2600, which may be an embodiment of the host 2316 of FIG. 23, in accordance with various aspects described herein. As used herein, the host 2600 may be or comprise various combinations hardware and/or software, including a standalone server, a blade server, a cloud-implemented server, a distributed server, a virtual machine, container, or processing resources in a server farm. The host 2600 may provide one or more services to one or more UEs.

The host 2600 includes processing circuitry 2602 that is operatively coupled via a bus 2604 to an input/output interface 2606, a network interface 2608, a power source 2610, and a memory 2612. Other components may be included in other embodiments. Features of these components may be substantially similar to those described with respect to the devices of previous figures, such as FIGS. 24 and 25, such that the descriptions thereof are generally applicable to the corresponding components of host 2600.

The memory 2612 may include one or more computer programs including one or more host application programs 2614 and data 2616, which may include user data, e.g., data generated by a UE for the host 2600 or data generated by the host 2600 for a UE. Embodiments of the host 2600 may utilize only a subset or all of the components shown. The host application programs 2614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2614 may also provide for user authentication and licensing checks and may periodically report health, routes, and content availability to a central node, such as a device in or on the edge of a core network. Accordingly, the host 2600 may select and/or indicate a different host for over-the-top services for a UE. The host application programs 2614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 27 is a block diagram illustrating a virtualization environment 2700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2702 (which may alternatively be called software instances, virtual appliances, network functions, virtual nodes, virtual network functions, etc.) are run in the virtualization environment 2700 to implement some of the features, functions, and/or benefits of some of the embodiments disclosed herein.

Hardware 2704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2706 (also referred to as hypervisors or virtual machine monitors (VMMs)), provide VMs 2708A and 2708B (one or more of which may be generally referred to as VMs 2708), and/or perform any of the functions, features and/or benefits described in relation with some embodiments described herein. The virtualization layer 2706 may present a virtual operating platform that appears like networking hardware to the VMs 2708.

The VMs 2708 comprise virtual processing, virtual memory, virtual networking or interface and virtual storage, and may be run by a corresponding virtualization layer 2706. Different embodiments of the instance of a virtual appliance 2702 may be implemented on one or more of VMs 2708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2708 may be a software implementation of a physical machine that runs programs as if they were executing on a physical, non-virtualized machine. Each of the VMs 2708, and that part of hardware 2704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2708 on top of the hardware 2704 and corresponds to the application 2702.

Hardware 2704 may be implemented in a standalone network node with generic or specific components. Hardware 2704 may implement some functions via virtualization. Alternatively, hardware 2704 may be part of a larger cluster of hardware (e.g. such as in a data center or CPE) where many hardware nodes work together and are managed via management and orchestration 2710, which, among others, oversees lifecycle management of applications 2702. In some embodiments, hardware 2704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2712 which may alternatively be used for communication between hardware nodes and radio units.

FIG. 28 shows a communication diagram of a host 2802 communicating via a network node 2804 with a UE 2806 over a partially wireless connection in accordance with some embodiments. Example implementations, in accordance with various embodiments, of the UE (such as a UE 2312a of FIG. 23 and/or UE 2400 of FIG. 24), network node (such as network node 2310a of FIG. 23 and/or network node 2500 of FIG. 25), and host (such as host 2316 of FIG. 23 and/or host 2500 of FIG. 25) discussed in the preceding paragraphs will now be described with reference to FIG. 28.

Like host 2500, embodiments of host 2802 include hardware, such as a communication interface, processing circuitry, and memory. The host 2802 also includes software, which is stored in or accessible by the host 2802 and executable by the processing circuitry. The software includes a host application that may be operable to provide a service to a remote user, such as the UE 2806 connecting via an over-the-top (OTT) connection 2850 extending between the UE 2806 and host 2802. In providing the service to the remote user, a host application may provide user data which is transmitted using the OTT connection 2850.

The network node 2804 includes hardware enabling it to communicate with the host 2802 and UE 2806. The connection 2860 may be direct or pass through a core network (like core network 2306 of FIG. 23) and/or one or more other intermediate networks, such as one or more public, private, or hosted networks. For example, an intermediate network may be a backbone network or the Internet.

The UE 2806 includes hardware and software, which is stored in or accessible by UE 2806 and executable by the UE's processing circuitry. The software includes a client application, such as a web browser or operator-specific “app” that may be operable to provide a service to a human or non-human user via UE 2806 with the support of the host 2802. In the host 2802, an executing host application may communicate with the executing client application via the OTT connection 2850 terminating at the UE 2806 and host 2802. In providing the service to the user, the UE's client application may receive request data from the host's host application and provide user data in response to the request data. The OTT connection 2850 may transfer both the request data and the user data. The UE's client application may interact with the user to generate the user data that it provides to the host application through the OTT connection 2850.

The OTT connection 2850 may extend via a connection 2860 between the host 2802 and the network node 2804 and via a wireless connection 2870 between the network node 2804 and the UE 2806 to provide the connection between the host 2802 and the UE 2806. The connection 2860 and wireless connection 2870, over which the OTT connection 2850 may be provided, have been drawn abstractly to illustrate the communication between the host 2802 and the UE 2806 via the network node 2804, without explicit reference to any intermediary devices and the precise routing of messages via these devices.

As an example of transmitting data via the OTT connection 2850, in step 2808, the host 2802 provides user data, which may be performed by executing a host application. In some embodiments, the user data is associated with a particular human user interacting with the UE 2806. In other embodiments, the user data is associated with a UE 2806 that shares data with the host 2802 without explicit human interaction. In step 2810, the host 2802 initiates a transmission carrying the user data towards the UE 2806. The host 2802 may initiate the transmission responsive to a request transmitted by the UE 2806. The request may be caused by human interaction with the UE 2806 or by operation of the client application executing on the UE 2806. The transmission may pass via the network node 2804, in accordance with the teachings of the embodiments described throughout this disclosure. Accordingly, in step 2812, the network node 2804 transmits to the UE 2806 the user data that was carried in the transmission that the host 2802 initiated, in accordance with the teachings of the embodiments described throughout this disclosure. In step 2814, the UE 2806 receives the user data carried in the transmission, which may be performed by a client application executed on the UE 2806 associated with the host application executed by the host 2802.

In some examples, the UE 2806 executes a client application which provides user data to the host 2802. The user data may be provided in reaction or response to the data received from the host 2802. Accordingly, in step 2816, the UE 2806 may provide user data, which may be performed by executing the client application. In providing the user data, the client application may further consider user input received from the user via an input/output interface of the UE 2806. Regardless of the specific manner in which the user data was provided, the UE 2806 initiates, in step 2818, transmission of the user data towards the host 2802 via the network node 2804. In step 2820, in accordance with the teachings of the embodiments described throughout this disclosure, the network node 2804 receives user data from the UE 2806 and initiates transmission of the received user data towards the host 2802. In step 2822, the host 2802 receives the user data carried in the transmission initiated by the UE 2806.

In an example scenario, factory status information may be collected and analyzed by the host 2802. As another example, the host 2802 may process audio and video data which may have been retrieved from a UE for use in creating maps. As another example, the host 2802 may collect and analyze real-time data to assist in controlling vehicle congestion (e.g., controlling traffic lights). As another example, the host 2802 may store surveillance video uploaded by a UE. As another example, the host 2802 may store or control access to media content such as video, audio, VR or AR which it can broadcast, multicast or unicast to UEs. As other examples, the host 2802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2850 between the host 2802 and UE 2806, in response to variations in the measurement results. The measurement procedure and/or the network functionality for reconfiguring the OTT connection may be implemented in software and hardware of the host 2802 and/or UE 2806. In some embodiments, sensors (not shown) may be deployed in or in association with other devices through which the OTT connection 2850 passes; the sensors may participate in the measurement procedure by supplying values of the monitored quantities exemplified above, or supplying values of other physical quantities from which software may compute or estimate the monitored quantities. The reconfiguring of the OTT connection 2850 may include message format, retransmission settings, preferred routing etc.; the reconfiguring need not directly alter the operation of the network node 2804. Such procedures and functionalities may be known and practiced in the art. In certain embodiments, measurements may involve proprietary UE signaling that facilitates measurements of throughput, propagation times, latency and the like, by the host 2802. The measurements may be implemented in that software causes messages to be transmitted, in particular empty or ‘dummy’ messages, using the OTT connection 2850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

### Embodiments

1. A method in a wireless communication device (1400, 2312A, 2312B, 2312C, 2312D, 2400, 2704, 2708A, 2708B, 2806) configured in dual connectivity with a master cell group, MCG, controlled by a master node, MN, and a secondary cell group, SCG, controlled by a secondary node, SN, to perform access barring check, the method comprising:
   receiving (1701) SCG access barring information;
   identifying (1703) an access attempt;
   determining (1705) an access category for the access attempt; and
   performing (1707) an access barring check for the access attempt using the access category determined and access barring information.
2. The method of Embodiment 1, further comprising determining (1709) the outcome of the access barring check.
3. The method of any of Embodiments 1-2, further comprising:
   responsive to an outcome of the access barring check being to allow the access attempt, proceeding (1711) with the access attempt; and
   responsive to the outcome of the access barring check being to bar the access attempt, not proceeding (1713) with the access attempt.
4. The method of any of Embodiments 1-3, wherein receiving the SCG access barring information comprises receiving unified access control barring information.
5. The method of any of Embodiments 1-4, wherein receiving the SCG access barring information comprises receiving access barring information via dedicated radio resource control, RRC, signalling from the MN.
6. The method of any of Embodiments 1-4, wherein receiving the SCG access barring information comprises receiving the access barring information via system information transmitted from the SN.
7. The method of any of Embodiments 1-6, further comprising:
   obtaining (1801) MCG access barring information;
   determining (1803) whether to use the SCG access barring information or MCG access barring information in the access attempt.
8. The method of Embodiment 7, wherein performing an access barring check comprises applying MCG access barring information or SCG access barring information based on a type of the access attempt.
9. The method of any of Embodiments 1-8, wherein identifying an access attempt comprises mapping the access attempt onto one of access categories and access identities.
10. The method of any of Embodiments 1-9 wherein performing the access barring check comprises using the SCG access barring information to determine whether network-triggered SCG activation is barred.
11. The method of any of Embodiments 1-10, further comprising:
   determining (1901) to initiate setup of a new service or session corresponding to an access category for which the wireless communication device does not currently have any service or session established;
   determining (1903) that access for the access category is barred for the wireless communication device in a PCell used by the wireless communication device;
   determining (1905) whether access for the new service or session is barred in a PSCell used by the wireless communication device;
   responsive to the access for the new service or session not being barred in the PSCell, initiating (1907) the setup of the new service or session in the PSCell.
12. The method of any of Embodiments 1-10, further comprising:
   determining (2001) to initiate setup of a new service or session corresponding to an access category for which the wireless communication device does not current have any service or session established;
   determining (2003) that access for the access category is barred for the wireless communication device in a PSCell used by the wireless communication device;
   determining (2005) whether access for the new service or session is barred in a PCell used by the wireless communication device;
   responsive to the access for the new service or session not being barred in the PCell, indicating (2007) to a network through signaling or via a PCell/MCG, that the service or session is barred for the wireless communication device in the PSCell of the wireless communication device for the network to configure the new service or session.
13. A method by a network node (1400, 2310A, 2310B, 2500, 2704, 2708A, 2708B, 2804) to perform access barring, the method comprising:
   generating (2101) secondary cell group, SCG, access barring information; and
   sending (2103) the SCG access barring information towards a user equipment, UE, (1400, 2312A, 2312B, 2312C, 2312D, 2400, 2704, 2708A, 2708B, 2806) configured in dual connectivity using the network node as a secondary node, SN.
14. The method of Embodiment 13, wherein the UE is connected to a PSCell and a PCell, the method further comprising:
   receiving (2201) an indication from the UE that access to a service or session is barred for the UE in the PSCell but allowed in the PCell; and
   configuring (2203) the service or session so that no resources are used in the PSCell.
15. The method of any of Embodiments 13-14, wherein sending the SCG access barring information towards the UE comprises providing the SCG access barring information in system information transmitted from the network node to the UE.
16. The method of Embodiment 15, wherein providing the SCG access barring information in system information transmitted from the network node to the UE comprises broadcasting the system information only to UEs using a current cell as a PSCell of the SCG.
17. A wireless communication device (1400, 2312A, 2312B, 2312C, 2312D, 2400, 2704, 2708A, 2708B, 2806) configured in dual connectivity with a master cell group, MCG, controlled by a master node, MN, and a secondary cell group, SCG, controlled by a secondary node, SN, to perform access barring check, the wireless communication device comprising:
   processing circuitry (1403, 2402, 2712); and
   memory (1405, 2410) coupled with the processing circuitry, wherein the memory includes instructions that when executed by the processing circuitry causes the communication device to:
      receive (1701) SCG access barring information;
      identify (1703) an access attempt;
      determine (1705) an access category for the access attempt; and
      perform (1707) an access barring check for the access attempt using the access category determined and access barring information.
18. The wireless communication device of Embodiment 17, wherein the memory includes further instructions that when executed by the processing circuitry causes the communication device to perform operations according to Embodiments 2-12.
19. A wireless communication device (1400, 2312A, 2312B, 2312C, 2312D, 2400, 2704, 2708A, 2708B, 2806) configured in dual connectivity with a master cell group, MCG, controlled by a master node, MN, and a secondary cell group, SCG, controlled by a secondary node, SN, to perform access barring check, the wireless communication device adapted to:
   receive (1701) SCG access barring information;
   identify (1703) an access attempt;
   determine (1705) an access category for the access attempt; and
   perform (1707) an access barring check for the access attempt using the access category determined and access barring information.
20. The wireless communication device of Embodiment 19, wherein the wireless communication device is further adapted to perform according to Embodiments 2-12.
21. A computer program comprising program code to be executed by processing circuitry (1403, 2402, 2712) of a wireless communication device (1400, 2312A, 2312B, 2312C, 2312D, 2400, 2704, 2708A, 2708B, 2806), whereby execution of the program code causes the wireless communication device to perform operations according to any of Embodiments 1-12.
22. A computer program product comprising a non-transitory storage medium including program code to be executed by processing circuitry (1403, 2402, 2712) of a communication device (1400, 2312A, 2312B, 2312C, 2312D, 2400, 2704, 2708A, 2708B, 2806), whereby execution of the program code causes the wireless communication device to perform operations according to any of Embodiments 1-12.
23. A network node (1500, 2310A, 2310B, 2500, 2704, 2708A, 2708B, 2804) acting as a secondary node, the network node comprising:
   processing circuitry (1503, 2502); and
   memory (1505, 2504) coupled with the processing circuitry, wherein the memory includes instructions that when executed by the processing circuitry causes the network node to:
      generate (2101) secondary cell group, SCG, access barring information; and
      send (2103) the SCG access barring information towards a user equipment, UE, (1400, 2312A, 2312B, 2312C, 2312D, 2400, 2704, 2708A, 2708B, 2806) configured in dual connectivity using the network node as a secondary node, SN.
24. The network node of Embodiment 23, wherein the memory includes further instructions that when executed by the processing circuitry causes the network node to perform according to any of Embodiments 14-16.
25. A network node (1500, 2310A, 2310B, 2500, 2704, 2708A, 2708B, 2804) adapted to:
   generate (2101) secondary cell group, SCG, access barring information; and
   send (2103) the SCG access barring information towards a user equipment, UE, (1400, 2312A, 2312B, 2312C, 2312D, 2400, 2704, 2708A, 2708B, 2806) configured in dual connectivity using the network node as a secondary node, SN.
26. The network node of Embodiment 25 wherein the network node is further adapted to perform according to any of Embodiments 14-16.
27. A computer program comprising program code to be executed by processing circuitry (1503, 2502) of a radio access network, RAN, node (1500, 2310A, 2310B, 2500, 2704, 2708A, 2708B, 2804), whereby execution of the program code causes the RAN node (1500, 2310A, 2310B, 2500, 2704, 2708A, 2708B, 2804) to perform operations according to any of Embodiments 13-16.
28. A computer program product comprising a non-transitory storage medium including program code to be executed by processing circuitry (1503, 2502) of a network node (1500, 2310A, 2310B, 2500, 2704, 2708A, 2708B, 2804), whereby execution of the program code causes the network node (1500, 2310A, 2310B, 2500, 2704, 2708A, 2708B, 2804) to perform operations according to any of Embodiments 13-16.

### REFERENCES ARE IDENTIFIED BELOW

3GPP TS 22.261 v18.2.0; (2021 April) 3rd Generation Partnership Project; Technical Specification Group Services and System Aspects; Service requirements for the 5G system; Stage 1 (Release 18)
3GPP TS 24.501 v17.2.1. (2021 April) 3rd Generation Partnership Project; Technical Specification Group; Technical Specification Group Core Network and Terminals; Non-Access-Stratum (NAS) protocol for 5G System (5GS); Stage 3; (Release 17)
3GPP TS 38.331 v16.4.1 (2021 March); 3rd Generation Partnership Project; Technical Specification Group Radio Access Network; NR; Radio Resource Control (RRC) protocol specification (Release 16)
3GPP TS 37.340 v 16.5.0 (2021 March); 3rd Generation Partnership Project; Technical Specification Group Radio Access Network; Evolved Universal Terrestrial Radio Access (E-UTRA) and NR; Multi-connectivity; Stage 2 (Release 16)
3GPP TS 36.423 v 16.5.0 (2021 April); 3rd Generation Partnership Project; Technical Specification Group Radio Access Network; Evolved Universal Terrestrial Radio Access Network (E-UTRAN); X2 application protocol (X2AP) (Release 16)

1. A method in a wireless communication device configured in dual connectivity with a master cell group, MCG, controlled by a master node, MN, and a secondary cell group, SCG, controlled by a secondary node, SN, to perform access barring check, the method comprising:
receiving SCG access barring information;
identifying an access attempt;
determining an access category for the access attempt; and
performing an access barring check for the access attempt using the access category determined and access barring information.

2. The method of claim 1, further comprising determining the outcome of the access barring check.

3. The method of claim 1, further comprising:
responsive to an outcome of the access barring check being to allow the access attempt, proceeding with the access attempt; and
responsive to the outcome of the access barring check being to bar the access attempt, not proceeding with the access attempt.

4. The method of claim 1, wherein receiving the SCG access barring information comprises receiving unified access control barring information.

5. The method of claim 1, wherein receiving the SCG access barring information comprises receiving access barring information via dedicated radio resource control, RRC, signalling from the MN.

6. The method of claim 1, wherein receiving the SCG access barring information comprises receiving the access barring information via system information transmitted from the SN.

7. The method of claim 1, further comprising:
obtaining MCG access barring information; and
determining whether to use the SCG access barring information or MCG access barring information in the access attempt.

8. The method of claim 7, wherein performing an access barring check comprises applying MCG access barring information or SCG access barring information based on a type of the access attempt.

9. The method of claim 1, wherein identifying an access attempt comprises mapping the access attempt onto one of access categories and access identities.

10. The method of claim 1 wherein performing the access barring check comprises using the SCG access barring information to determine whether network-triggered SCG activation is barred.

11. The method of claim 1, further comprising:
determining to initiate setup of a new service or session corresponding to an access category for which the wireless communication device does not currently have any service or session established;
determining that access for the access category is barred for the wireless communication device in a primary cell, PCell, used by the wireless communication device;
determining whether access for the new service or session is barred in a secondary primary cell, PSCell, used by the wireless communication device; and
responsive to the access for the new service or session not being barred in the PSCell, initiating the setup of the new service or session in the PSCell.

12. The method of claim 1, further comprising:
determining to initiate setup of a new service or session corresponding to an access category for which the wireless communication device does not current have any service or session established;
determining that access for the access category is barred for the wireless communication device in a secondary primary cell, PSCell, used by the wireless communication device;
determining whether access for the new service or session is barred in a primary cell, PCell, used by the wireless communication device; and
responsive to the access for the new service or session not being barred in the PCell, indicating to a network through signaling or via a PCell/MCG, that the service or session is barred for the wireless communication device in the PSCell of the wireless communication device for the network to configure the new service or session.

13. A method by a network node to perform access barring, the method comprising:
generating secondary cell group, SCG, access barring information; and
sending the SCG access barring information towards a user equipment, UE, configured in dual connectivity using the network node as a secondary node, SN.

14. The method of claim 13, wherein the UE is connected to a primary secondary cell, PSCell, and a primary cell, PCell, the method further comprising:
receiving an indication from the UE that access to a service or session is barred for the UE in the PSCell but allowed in the PCell; and
configuring the service or session so that no resources are used in the PSCell.

15. The method of claim 13, wherein sending the SCG access barring information towards the UE comprises providing the SCG access barring information in system information transmitted from the network node to the UE.

16. The method of claim 15, wherein providing the SCG access barring information in system information transmitted from the network node to the UE comprises broadcasting the system information only to UEs using a current cell as a PSCell of the SCG.

17. A wireless communication device configured in dual connectivity with a master cell group, MCG, controlled by a master node, MN, and a secondary cell group, SCG, controlled by a secondary node, SN, to perform access barring check, the wireless communication device comprising:
processing circuitry; and
memory coupled with the processing circuitry, wherein the memory includes instructions that when executed by the processing circuitry causes the communication device to:
receive SCG access barring information;
identify an access attempt;
determine an access category for the access attempt; and
perform an access barring check for the access attempt using the access category determined and access barring information.

18. The wireless communication device of claim 17, wherein the memory includes further instructions that when executed by the processing circuitry causes the communication device to perform further operations comprising determining the outcome of the access barring check.

19.-22. (canceled)

23. A network node acting as a secondary node, the network node comprising:
processing circuitry; and
memory coupled with the processing circuitry, wherein the memory includes instructions that when executed by the processing circuitry causes the network node to:
generate secondary cell group, SCG, access barring information; and
send the SCG access barring information towards a user equipment, UE, configured in dual connectivity using the network node as a secondary node, SN.

24. The network node of claim 23, wherein the memory includes further instructions that when executed by the processing circuitry causes the network node to further perform operations comprising:
receive an indication from the UE that access to a service or session is barred for the UE in the PSCell but allowed in the PCell; and
configure the service or session so that no resources are used in the PSCell.

25.-28. (canceled)
